(19) United States
(12) Patent Application Publication
(10) Pub. No.: US 2022/0215596 A1
(43) Pub. Date: Jul. 7, 2022

(54) MODEL-BASED PREDICTION FOR GEOMETRY POINT CLOUD COMPRESSION

(71) Applicant: QUALCOMM Incorporated, San Diego, CA (US)

(72) Inventors: Geert Van der Auwera, Del Mar, CA (US); Adarsh Krishnan Ramasubramonian, Irvine, CA (US); Bappaditya Ray, San Diego, CA (US); Luong Pham Van, San Diego, CA (US); Marta Karczewicz, San Diego, CA (US)

(21) Appl. No.: 17/562,121

(22) Filed: Dec. 27, 2021

Related U.S. Application Data
(60) Provisional application No. 63/133,622, filed on Jan. 4, 2021.

(51) Int. Cl. G06T 9/40

(52) U.S. Cl. CPC G06T 9/40

(57) ABSTRACT

Techniques are disclosed for coding point cloud data using a scene model. An example device for coding point cloud data includes a memory configured to store the point cloud data and one or more processors implemented in circuitry and communicatively coupled to the memory. The one or more processors are configured to determine or obtain a scene model corresponding with a first frame of the point cloud data, wherein the scene model represents objects within a scene, the objects corresponding with at least a portion of the first frame of the point cloud data. The one or more processors are also configured to code a current frame of the point cloud data based on the scene model.

This application claims the benefit of U.S. Provisional Application No. 63/133,622, filed Jan. 4, 2021, and entitled “MODEL-BASED PREDICTION FOR GEOMETRY POINT CLOUD COMPRESSION,” the entire content of which is incorporated by reference herein.

### TECHNICAL FIELD

This disclosure relates to point cloud encoding and decoding.

### BACKGROUND

A point cloud is a collection of points in a 3-dimensional space. The points may correspond to points on objects within the 3-dimensional space. Thus, a point cloud may be used to represent the physical content of the 3-dimensional space. Point clouds may have utility in a wide variety of situations. For example, point clouds may be used in the context of autonomous vehicles for representing the positions of objects on a roadway. In another example, point clouds may be used in the context of representing the physical content of an environment for purposes of positioning virtual objects in an augmented reality (AR) or mixed reality (MR) application. Point cloud compression is a process for encoding and decoding point clouds. Encoding point clouds may reduce the amount of data required for storage and transmission of point clouds.

### SUMMARY

In general, this disclosure describes techniques for modeling an input point cloud. The techniques of this disclosure may be employed for prediction of a current frame or the subsequent frames in a set of point cloud frames.

With geometry point cloud compression (G-PCC), a point cloud may be coded with or without using a sensor model to improve coding efficiency. However, this compression may be performed without using information related to the scene, such as location of objects. By obtaining or otherwise determining a scene model, and using the scene model to code the point cloud data, additional coding efficiencies may be gained.

In one example, this disclosure describes a method of coding point cloud data, the method comprising determining or obtaining a scene model corresponding with a first frame of the point cloud data, wherein the scene model represents objects within a scene, the objects corresponding with at least a portion of the first frame of the point cloud data; and coding a current frame of the point cloud data based on the scene model.

In one example, this disclosure describes a device for coding point cloud data, the device comprising: a memory configured to store the point cloud data; and one or more processors implemented in circuitry and communicatively coupled to the memory, the one or more processors being configured to: determine or obtain a scene model corresponding with a first frame of the point cloud data, wherein the scene model represents objects within a scene, the objects corresponding with at least a portion of the first frame of the point cloud data; and code a current frame of the point cloud data based on the scene model.

In one example, this disclosure describes a non-transitory computer-readable storage medium having stored thereon instructions that, when executed, cause one or more processors to: determine or obtain a scene model corresponding with a first frame of point cloud data, wherein the scene model represents objects within a scene, the objects corresponding with at least a portion of the first frame of the point cloud data; and code a current frame of the point cloud data based on the scene model.

In one example, this disclosure describes a device for coding point cloud data, the device comprising: means for determining or obtaining a scene model corresponding with a first frame of the point cloud data, wherein the scene model represents objects within a scene, the objects corresponding with at least a portion of the first frame of the point cloud data; and means for coding a current frame of the point cloud data based on the scene model.

In one example, this disclosure describes a method of coding point cloud data, the method comprising determining a sensor model comprising at least one intrinsic or extrinsic parameters of one or more sensors configured to acquire the point cloud data, and coding the point cloud data based on the sensor model.

In another example, this disclosure describes a device for coding point cloud data, the device comprising memory configured to store the point cloud data and one or more processors implemented in circuitry and communicatively coupled to the memory, the one or more processors being configured to perform any techniques of this disclosure.

In another example, this disclosure describes a device for coding point cloud data, the device comprising one or more means for performing any techniques of this disclosure.

In yet another example, this disclosure describes a non-transitory, computer-readable storage medium, storing instructions, which, when executed, cause one or more processors to perform any techniques of this disclosure.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 is a block diagram illustrating an example Geometry Point Cloud Compression (G-PCC) encoder.

FIG. 3 is a block diagram illustrating an example G-PCC decoder.

FIG. 4 is a conceptual diagram illustrating an example octree split for geometry coding according to the techniques of this disclosure.

FIG. 5 is a conceptual diagram of a prediction tree for predictive geometry coding.

FIGS. 6A and 6B are conceptual diagrams illustrating an example of a spinning LIDAR acquisition model.

FIG. 7 is a flow diagram illustrating example scene model coding techniques of this disclosure.

FIG. 8 is a flow diagram illustrating example scene model coding techniques of this disclosure.

FIG. 9 is a conceptual diagram illustrating an example range-finding system that may be used with one or more techniques of this disclosure.

FIG. 10 is a conceptual diagram illustrating an example vehicle-based scenario in which one or more techniques of this disclosure may be used.

FIG. 11 is a conceptual diagram illustrating an example extended reality system in which one or more techniques of this disclosure may be used.

FIG. 12 is a conceptual diagram illustrating an example mobile device system in which one or more techniques of this disclosure may be used.

### DETAILED DESCRIPTION

Point cloud encoding or decoding, such as geometry point cloud compression (G-PCC), may utilize octree-based or predictive-based geometry coding techniques (described below), optionally in combination with prior knowledge about a sensor. This prior knowledge may include angular data and position offsets of multiple lasers within a LIDAR sensor, for example, which may result in significant coding efficiency gains for LIDAR captured point clouds. However, a point cloud encoder or decoder may have no information available about a three-dimensional (3D) scene corresponding to the point cloud. In some cases, the scene may be understood as providing a geometrical context (e.g., contextual information) for coding the point cloud. In this regard, this disclosure proposes utilizing a (3D) scene model to improve coding efficiency. According to the techniques of this disclosure, a scene model may be obtained (e.g., received from an external device) or determined, and a G-PCC coder may use this scene model, alone or together with the sensor model, to improve the efficiency of coding the point cloud positions and/or the point cloud attributes. A point cloud may be defined as a collection of points with positions Xₙ=(xₙ, yₙ, zₙ), n=1, . . . , N, where N is the number of points in the point cloud, and optional attributes Aₙ=(A₁ₙ, A₂ₙ, . . . , Aₙ), n=1, . . . , N, where D is the number of attributes for each point. Yet, coding efficiency improvements are dependent on whether the obtained or derived scene model is an accurate representation of the scene which is formed by the point cloud. In this regard, it is recognized that the scene model may be obtained or derived for coding a point cloud of a number of frames (e.g., two, three, . . . , ten) or even of one (a single) frame. A scene model may be a digital representation of a real-world scene. For example, a scene model may be mesh-based (including vertices with connectivity information), or other representation of surfaces and objects within a scene, such as planes representing a grouping of points within defined regions of a point cloud. In some examples, an actual scene model (e.g., a city model) may be externally provided (e.g., from an external server) to an encoder and/or a decoder, or may be signaled by the encoder to the decoder as side information for a sequence of point cloud frames and be used for coding the point cloud frames. In some examples, a scene model may be determined by the encoder using a current frame, and may be signaled and used as predictor for current frame (e.g., using intra prediction). In some examples, a signaled scene model(s) from previous frame(s) may be used as predictor for the current frame (e.g., using inter prediction). In some examples, a scene model may be estimated from prior reconstructed frame(s) and used for prediction for the current frame (e.g., using inter prediction). In some cases, a prior scene model may be used to code the scene model of the current frame, where scene model residual(s) may be signaled by the encoder to the decoder and be used to predict the current frame. The techniques of this disclosure may reduce the bandwidth needed to transmit and the memory needed to store the encoded point cloud.

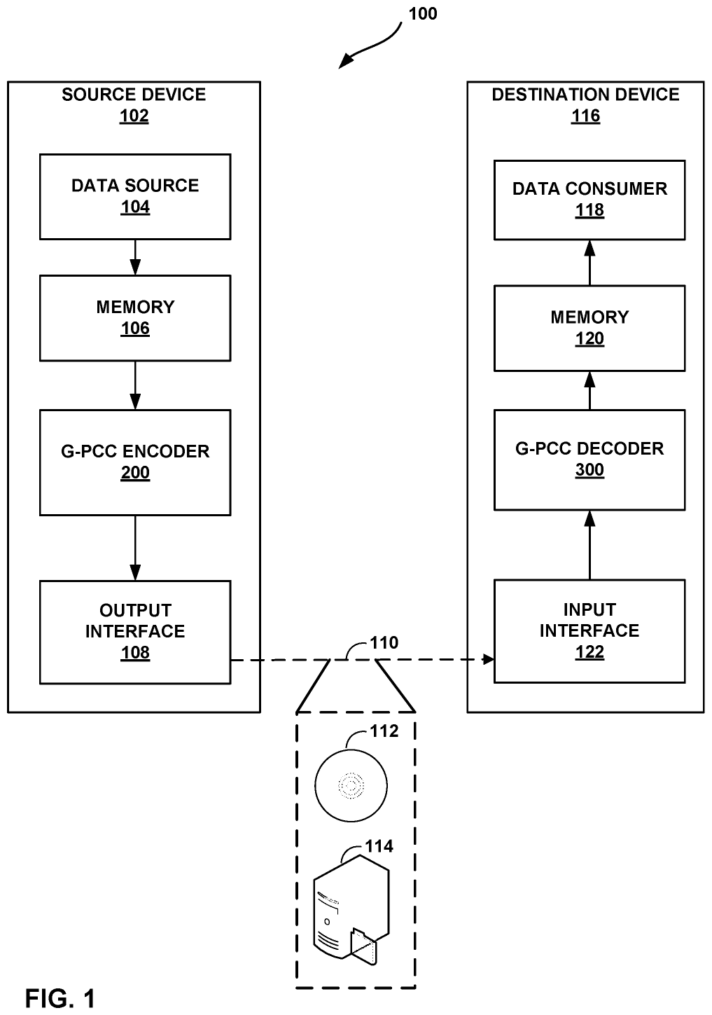

FIG. 1 is a block diagram illustrating an example encoding and decoding system 100 that may perform the techniques of this disclosure. The techniques of this disclosure are generally directed to coding (encoding and/or decoding) point cloud data, i.e., to support point cloud compression. In general, point cloud data includes any data for processing a point cloud. The coding may be effective in compressing and/or decompressing point cloud data.

As shown in FIG. 1, system 100 includes a source device 102 and a destination device 116. Source device 102 provides encoded point cloud data to be decoded by a destination device 116. Particularly, in the example of FIG. 1, source device 102 provides the point cloud data to destination device 116 via a computer-readable medium 110. Source device 102 and destination device 116 may comprise any of a wide range of devices, including desktop computers, notebook (e.g., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR (Light Detection and Ranging) devices, satellites, or the like. In some cases, source device 102 and destination device 116 may be equipped for wireless communication.

In the example of FIG. 1, source device 102 includes a data source 104, a memory 106, a G-PCC encoder 200, and an output interface 108. Destination device 116 includes an input interface 122, a G-PCC decoder 300, a memory 120, and a data consumer 118. In accordance with this disclosure, G-PCC encoder 200 of source device 102 and G-PCC decoder 300 of destination device 116 may be configured to apply the techniques of this disclosure related to modeling an input point cloud. Thus, source device 102 represents an example of an encoding device, while destination device 116 represents an example of a decoding device. In other examples, source device 102 and destination device 116 may include other components or arrangements. For example, source device 102 may receive data (e.g., point cloud data) from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to model an input point cloud. Source device 102 and destination device 116 are merely examples of such devices in which source device 102 generates coded data for transmission to destination device 116. This disclosure refers to a “coding” device as a device that performs coding (encoding and/or decoding) of data. Thus, G-PCC encoder 200 and G-PCC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (e.g., raw, unencoded point cloud data) and may provide a sequential series of “frames”) of the data to G-PCC encoder 200, which encodes data for the frames. Data source 104 of source device 102 may include a point cloud capture device, such as any of a variety of cameras or sensors, e.g., a 3D scanner or a LIDAR device, one or more video cameras, an archive containing previously captured data, and/or a data feed interface to receive data from a data content provider. Alternatively, or additionally, point cloud data may be computer-generated from scanner, camera, sensor or other data. For example, data source 104 may generate computer graphics-based data as the source data, or produce a combination of live data, archived data, and computer-generated data. In each case, G-PCC encoder 200 encodes the captured, pre-captured, or computer-generated data. G-PCC encoder 200 may rearrange the frames from the received order (sometimes referred to as “display order”) into a coding order for coding. G-PCC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from G-PCC decoder 300. Additionally, or alternatively, memory 106 and memory 120 may store software instructions executable by, e.g., G-PCC encoder 200 and G-PCC decoder 300, respectively. Although memory 106 and memory 120 are shown separately from G-PCC encoder 200 and G-PCC decoder 300 in this example, it should be understood that G-PCC encoder 200 and G-PCC decoder 300 may also include internal memories for functionally similar or equivalent purposes. Furthermore, memory 106 and memory 120 may store encoded data, e.g., output from G-PCC encoder 200 and input to G-PCC decoder 300. In some examples, portions of memory 106 and memory 120 may be allocated as one or more buffers, e.g., to store raw, decoded, and/or encoded data. For instance, memory 106 and memory 120 may store data representing a point cloud.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both, that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to G-PCC encoder 200 and/or output interface 108, and destination device 116 may include an SoC device to perform the functionality attributed to G-PCC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by G-PCC encoder 200, which is also used by G-PCC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on a point cloud.

G-PCC encoder 200 and G-PCC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of G-PCC encoder 200 and G-PCC decoder 300 may be included in one or more encoders or decoders, either of which may be integrated as part of a combined encoder/decoder (CODEC) in a respective device. A device including G-PCC encoder 200 and/or G-PCC decoder 300 may comprise one or more integrated circuits, microprocessors, and/or other types of devices.

G-PCC encoder 200 and G-PCC decoder 300 may operate according to a coding standard, such as video point cloud compression (V-PCC) standard or a geometry point cloud compression (G-PCC) standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, G-PCC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

ISO/IEC MPEG (JTC 1/SC 29/WG 11), and more recently ISO/IEC MPEG 3DG (JTC 1/SC29/WG 7), are studying the potential need for standardization of point cloud coding technology with a compression capability that significantly exceeds that of the current approaches and will target to create the standard. MPEG is working together on this exploration activity in a collaborative effort known as the 3-Dimensional Graphics Team (3DG) to evaluate compression technology designs proposed by their experts in this area.

Point cloud compression activities are categorized in two different approaches. The first approach is “Video point cloud compression” (V-PCC), which segments the 3D object, and project the segments in multiple 2D planes (which are represented as “patches” in the 2D frame), which are further coded by a legacy 2D video codec such as a High Efficiency Video Coding (HEVC) (ITU-T H.265) codec. The second approach is “Geometry-based point cloud compression” (G-PCC), which directly compresses 3D geometry, e.g., position of a set of points in 3D space, and associated attribute values (for each point associated with the 3D geometry). G-PCC addresses the compression of point clouds in both Category 1 (static point clouds) and Category 3 (dynamically acquired point clouds). A recent draft of the G-PCC standard is available in ISO/IEC FDIS 23090-9 Geometry-based Point Cloud Compression, ISO/IEC JTC 1/SC29/WG 7 MDS19617, Teleconference, October 2020, and a description of the codec is available in G-PCC Codec Description, ISO/IEC JTC 1/SC29/WG 7 MDS19620, Teleconference, October 2020 (hereinafter “G-PCC Codec Description”).

A point cloud contains a set of points in a 3D space and may have attributes associated with the point. The attributes may be color information such as R, G, B, or Y, Cb, Cr, or reflectance information, or other attributes. Point clouds may be captured by a variety of cameras or sensors, such as LIDAR sensors and 3D scanners, and may also be computer-generated. Point cloud data are used in a variety of applications including, but not limited to, construction (modeling), graphics (3D models for visualizing and animation), and the automotive industry (LIDAR sensors used to help in navigation).

The 3D space occupied by a point cloud may be enclosed by a virtual bounding box. The position of the points in the bounding box may be represented by a certain precision; therefore, the positions of one or more points may be quantized based on the precision. At the smallest level, the bounding box is split into voxels which are the smallest unit of space represented by a unit cube. A voxel in the bounding box may be associated with zero, one, or more than one point. The bounding box may be split into multiple cube/cuboid regions, which may be called tiles. Each tile may be coded into one or more slices. The partitioning of the bounding box into slices and tiles may be based on number of points in each partition, or based on other considerations (e.g., a particular region may be coded as tiles). The slice regions may be further partitioned using splitting decisions similar to those in video codecs.

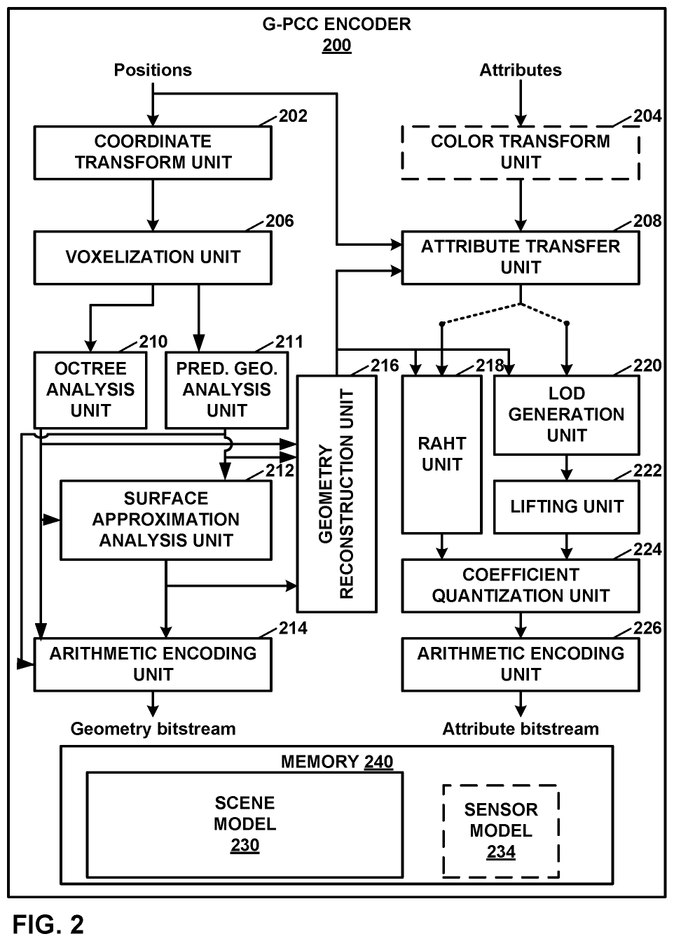

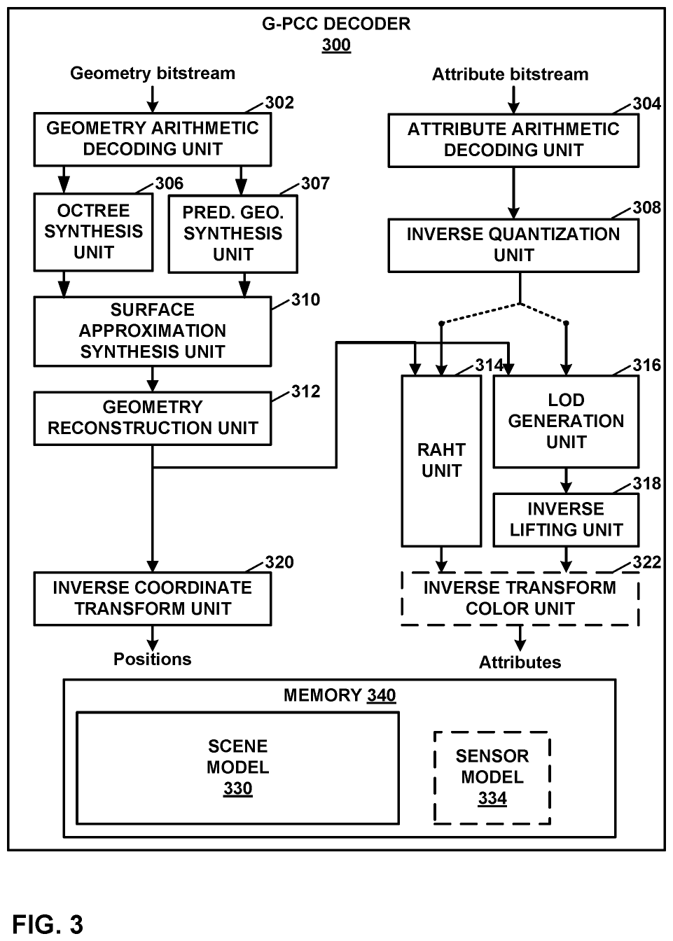

FIG. 2 provides an overview of G-PCC encoder 200. FIG. 3 provides an overview of G-PCC decoder 300. The modules shown are logical, and do not necessarily correspond one-to-one to implemented code in the reference implementation of a G-PCC codec, e.g., TMC13 test model software studied by ISO/IEC MPEG (JTC 1/SC 29/WG 11).

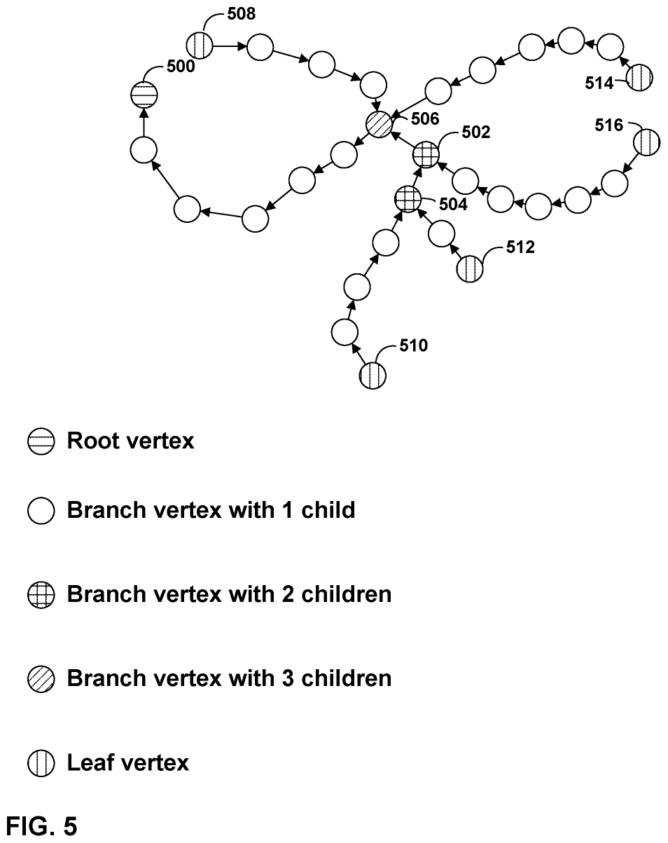

In both G-PCC encoder 200 and G-PCC decoder 300, point cloud positions are coded first and the coding of point cloud attributes depends on the coded geometry. The geometry of the point cloud comprises the point positions only. In some examples, G-PCC encoder 200 and G-PCC decoder 300 may use predictive geometry coding. For example, G-PCC encoder 200 may include predictive geometry analysis unit 211 and G-PCC decoder 300 may include predictive geometry synthesis unit 307 for performing predictive geometry coding. Predictive geometry coding is discussed in more detail later in this disclosure with respect to FIG. 5. In some examples, G-PCC encoder 200 or G-PCC decoder 300 may obtain scene model 230 from an external device, such as a server. In some examples, G-PCC encoder or G-PCC decoder may determine scene model 230 or scene model 330. In the case where G-PCC encoder or G-PCC decoder may determine scene model 230 or scene model 330, the scene model may be referred to as an estimated scene model or a determined scene model. In some examples, G-PCC encoder 200 may use scene model 230 and/or, optionally, sensor model 234 when encoding point cloud positions and/or attributes. In some examples, G-PCC decoder 300 may use scene model 330, and/or, optionally, sensor model 334 when decoding point cloud positions and/or attributes. In some examples, scene model 230 is the same as scene model 330. In some examples, sensor model 234 is the same as sensor model 334. Scene model 230 and/or, optionally, sensor model 234, may be stored in memory 240 of G-PCC encoder 200. Similarly, scene model 330, and/or, optionally, sensor model 334, may be stored in memory 340 of G-PCC decoder 300.

In FIG. 2, surface approximation analysis unit 212 and RAHT unit 218 are options typically used for Category 1 data. LoD generation unit 220 and lifting unit 222 are options typically used for Category 3 data. In FIG. 3, surface approximation synthesis unit 310 and RAHT unit 314 are options typically used for Category 1 data. LoD generation unit 316 and inverse lifting unit 318 are options typically used for Category 3 data. All the other modules may be common between Categories 1 and 3.

For octree coding, with Category 3 data, the compressed geometry is typically represented as an octree from the root all the way down to a leaf level of individual voxels. With Category 1 data, the compressed geometry is typically represented by a pruned octree (e.g., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the octree geometry codec.

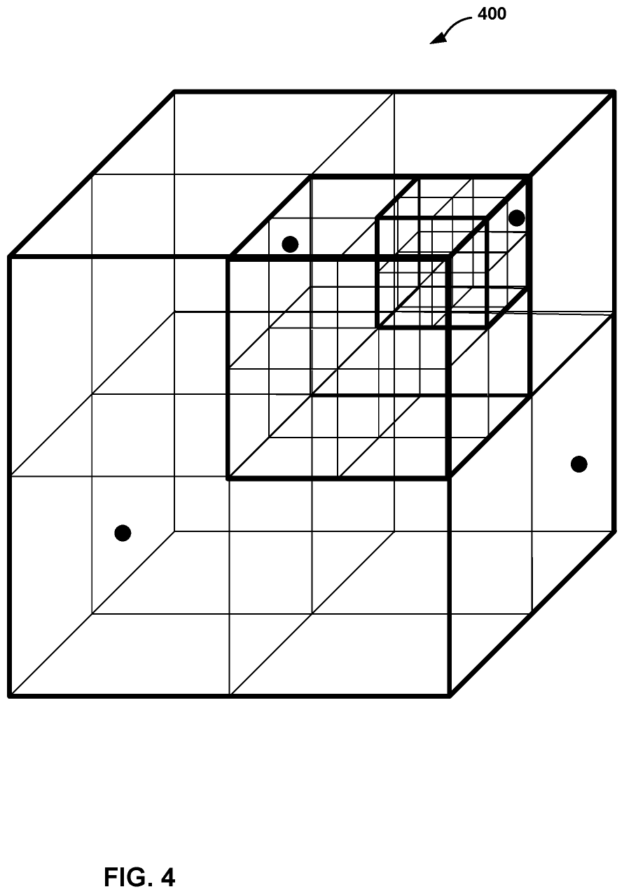

FIG. 4 is a conceptual diagram illustrating an example octree split for geometry coding according to the techniques of this disclosure. In the example shown in FIG. 4, octree 400, may be split into a series of nodes. For example, each node may be a cubic node. At each node of an octree, G-PCC encoder 200 may signal an occupancy of a node by a point of the point cloud to G-PCC decoder 300, when the occupancy is not inferred by G-PCC decoder 300, for one or more of the node's child nodes, which may include up to eight nodes. Multiple neighborhoods are specified including (a) nodes that share a face with a current octree node, (b) nodes that share a face, edge, or a vertex with the current octree node, etc. Within each neighborhood, the occupancy of a node and/or its children may be used to predict the occupancy of the current node or its children. For points that are sparsely populated in certain nodes of the octree, the codec also supports a direct coding mode where the 3D position of the point is encoded directly. A flag may be signaled to indicate that a direct mode is signaled. With a direct mode, positions of points in the point cloud may be coded directly without any compression. At the lowest level, the number of points associated with the octree node/leaf node may also be coded.

Once the geometry is coded, the attributes corresponding to the geometry points are coded. When there are multiple attribute points corresponding to one reconstructed/decoded geometry point, an attribute value may be derived that is representative of the reconstructed point.

There are three attribute coding methods in G-PCC: Region Adaptive Hierarchical Transform (RAHT) coding, interpolation-based hierarchical nearest-neighbor prediction (Predicting Transform), and interpolation-based hierarchical nearest-neighbor prediction with an update/lifting step (Lifting Transform). RAHT and Lifting Transform are typically used for Category 1 data, while Predicting Transform is typically used for Category 3 data. However, any method may be used for any data, and, just like with the geometry codecs in G-PCC, the attribute coding method used to code the point cloud may be specified in the bitstream.

The coding of the attributes may be conducted in a level-of-detail (LoD), where with each level of detail a finer representation of the point cloud attribute may be obtained. Each level of detail may be specified based on distance metric from the neighboring nodes or based on a sampling distance.

At G-PCC encoder 200, the residuals obtained as the output of the coding methods for the attributes are quantized. The residuals may be obtained by subtracting the attribute value from a prediction that is derived based on the points in the neighborhood of the current point and based on the attribute values of points encoded previously. The quantized residuals may be coded using context adaptive arithmetic coding.

In the example of FIG. 2, G-PCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LoD generation unit 220, a lifting unit 222, a coefficient quantization unit 224, and an arithmetic encoding unit 226.

As shown in the example of FIG. 2, G-PCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to transform color information of the attributes to a different domain. For example, color transform unit 204 may transform color information from an RGB color space to a YCbCr color space.

Furthermore, in the example of FIG. 2, voxelization unit 206 may voxelize the transform coordinates. Voxelization of the transform coordinates may include quantization and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may entropy encode syntax elements representing the information of the octree and/or surfaces determined by surface approximation analysis unit 212. G-PCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud.

Furthermore, RAHT unit 218 may apply RAHT coding to the attributes of the reconstructed points. In some examples, under RAHT, the attributes of a block of 2×2×2 point positions are taken and transformed along one direction to obtain four low (L) and four high (H) frequency nodes. Subsequently, the four low frequency nodes (L) are transformed in a second direction to obtain two low (LL) and two high (LH) frequency nodes. The two low frequency nodes (LL) are transformed along a third direction to obtain one low (LLL) and one high (LLH) frequency node. The low frequency node LLL corresponds to DC coefficients and the high frequency nodes H, LH, and LLH correspond to AC coefficients. The transformation in each direction may be a 1-D transform with two coefficient weights. The low frequency coefficients may be taken as coefficients of the 2×2×2 block for the next higher level of RAHT transform and the AC coefficients are encoded without changes; such transformations continue until the top root node. The tree traversal for encoding is from top to bottom used to calculate the weights to be used for the coefficients; the transform order is from bottom to top. The coefficients may then be quantized and coded.

Alternatively, or additionally, LoD generation unit 220 and lifting unit 222 may apply LoD processing and lifting, respectively, to the attributes of the reconstructed points. LoD generation is used to split the attributes into different refinement levels. Each refinement level provides a refinement to the attributes of the point cloud. The first refinement level provides a coarse approximation and contains few points; the subsequent refinement level typically contains more points, and so on. The refinement levels may be constructed using a distance-based metric or may also use one or more other classification criteria (e.g., subsampling from a particular order). Thus, all the reconstructed points may be included in a refinement level. Each level of detail is produced by taking a union of all points up to particular refinement level: e.g., LoD1 is obtained based on refinement level RL1, LoD2 is obtained based on RL1 and RL2, . . . LoDN is obtained by union of RL1, RL2, . . . RLN. In some cases, LoD generation may be followed by a prediction scheme (e.g., predicting transform) where attributes associated with each point in the LoD are predicted from a weighted average of preceding points, and the residual is quantized and entropy coded. The lifting scheme builds on top of the predicting transform mechanism, where an update operator is used to update the coefficients and an adaptive quantization of the coefficients is performed.

RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. G-PCC encoder 200 may output these syntax elements in an attribute bitstream.

In the example of FIG. 3, G-PCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LoD generation unit 316, an inverse lifting unit 318, an inverse transform coordinate unit 320, and an inverse transform color unit 322.

G-PCC decoder 300 may obtain a geometry bitstream and an attribute bitstream. Geometry arithmetic decoding unit 302 of decoder 300 may apply arithmetic decoding (e.g., Context-Adaptive Binary Arithmetic Coding (CAB AC) or other type of arithmetic decoding) to syntax elements in the geometry bitstream. Similarly, attribute arithmetic decoding unit 304 may apply arithmetic decoding to syntax elements in the attribute bitstream.

Octree synthesis unit 306 may synthesize an octree based on syntax elements parsed from the geometry bitstream. Starting with the root node of the octree, the occupancy of each of the eight children node at each octree level is signaled in the bitstream. When the signaling indicates that a child node at a particular octree level is occupied, the occupancy of children of this child node is signaled. The signaling of nodes at each octree level is signaled before proceeding to the subsequent octree level. At the final level of the octree, each node corresponds to a voxel position; when the leaf node is occupied, one or more points may be specified to be occupying the voxel position. In some instances, some branches of the octree may terminate earlier than the final level due to quantization. In such cases, a leaf node is considered an occupied node that has no child nodes. In instances where surface approximation is used in the geometry bitstream, surface approximation synthesis unit 310 may determine a surface model based on syntax elements parsed from the geometry bitstream and based on the octree.

Furthermore, geometry reconstruction unit 312 may perform a reconstruction to determine coordinates of points in a point cloud. For each position at a leaf node of the octree, geometry reconstruction unit 312 may reconstruct the node position by using a binary representation of the leaf node in the octree. At each respective leaf node, the number of points at the respective leaf node is signaled; this indicates the number of duplicate points at the same voxel position. When geometry quantization is used, the point positions are scaled for determining the reconstructed point position values.

Inverse transform coordinate unit 320 may apply an inverse transform to the reconstructed coordinates to convert the reconstructed coordinates (e.g., positions) of the points in the point cloud from a transform domain back into an initial domain. The positions of points in a point cloud may be in floating point domain but point positions in G-PCC codec are coded in the integer domain. The inverse transform may be used to convert the positions back to the original domain.

Additionally, in the example of FIG. 3, inverse quantization unit 308 may inverse quantize attribute values. The attribute values may be based on syntax elements obtained from the attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. RAHT decoding is done from the top to the bottom of the tree. At each level, the low and high frequency coefficients that are derived from the inverse quantization process are used to derive the constituent values. At the leaf node, the values derived correspond to the attribute values of the coefficients. The weight derivation process for the points is similar to the process used at G-PCC encoder 200. Alternatively, LoD generation unit 316 and inverse lifting unit 318 may determine color values for points of the point cloud using a level of detail-based technique. LoD generation unit 316 decodes each LoD giving progressively finer representations of the attribute of points. With a predicting transform, LoD generation unit 316 derives the prediction of the point from a weighted sum of points that are in prior LoDs, or previously reconstructed in the same LoD. LoD generation unit 316 may add the prediction to the residual (which is obtained after inverse quantization) to obtain the reconstructed value of the attribute. When the lifting scheme is used, LoD generation unit 316 may also include an update operator to update the coefficients used to derive the attribute values. LoD generation unit 316 may also apply an inverse adaptive quantization in this case.

Furthermore, in the example of FIG. 3, inverse transform color unit 322 may apply an inverse color transform to the color values. The inverse color transform may be an inverse of a color transform applied by color transform unit 204 of G-PCC encoder 200. For example, color transform unit 204 may transform color information from an RGB color space to a YCbCr color space. Accordingly, inverse transform color unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

FIG. 5 is a conceptual diagram illustrating an example of a prediction tree. Predictive geometry coding was introduced as an alternative to octree geometry coding, where the nodes are arranged in a tree structure (which defines the prediction structure), and various prediction strategies are used to predict the coordinates of each node in the tree with respect to its predictors. FIG. 5 shows an example of a prediction tree, a directed graph where the arrows points to the prediction direction. Node 500 is the root vertex and has no predictors. Nodes 502 and 504 have two children. Node 506 has 3 children. Nodes 508, 510, 512, 514, and 516 are leaf nodes and these have no children. The remaining nodes each have one child. Every node has only one parent node.

Four prediction strategies are specified for each node based on its parent (p0), grand-parent (p1) and great-grand-parent (p2): 1) No prediction/zero prediction (0); 2) Delta prediction (p0); 3) Linear prediction (2*p0−p1); and 4) Parallelogram prediction (2*p0+p1−p2).

G-PCC encoder 200 may employ any algorithm to generate the prediction tree; the algorithm used may be determined based on the application/use case and several strategies may be used. Example strategies are described in the G-PCC Codec Description.

For each node, G-PCC encoder 200 may encode the residual coordinate values in the bitstream starting from the root node (e.g., node 500) in a depth-first manner. Predictive geometry coding may be useful for Category 3 (e.g., LIDAR-acquired) point cloud data, e.g., for low-latency applications. For example, G-PCC encoder 200 or G-PCC decoder 300 may use a predictor candidate list which may be populated with one or more candidates. G-PCC encoder 200 or G-PCC decoder 300 may select a candidate from the predictor candidate list to use for the predictive geometry coding.

Angular mode for predictive geometry coding is now described. Angular mode may be used in predictive geometry coding, where the characteristics of sensors (e.g., LIDAR sensors) may be utilized in coding the prediction tree more efficiently. The coordinates of the positions are converted to the (r, ϕ, i) (radius, azimuth, and laser index) and a prediction is performed in this domain (the residuals are coded in r, ϕ, i domain). Due to errors in rounding, coding in r, ϕ, i is not lossless and hence a second set of residuals may be coded which correspond to the Cartesian coordinates. A description of the encoding and decoding strategies used for angular mode for predictive geometry coding is generally reproduced below from the G-PCC Codec Description.

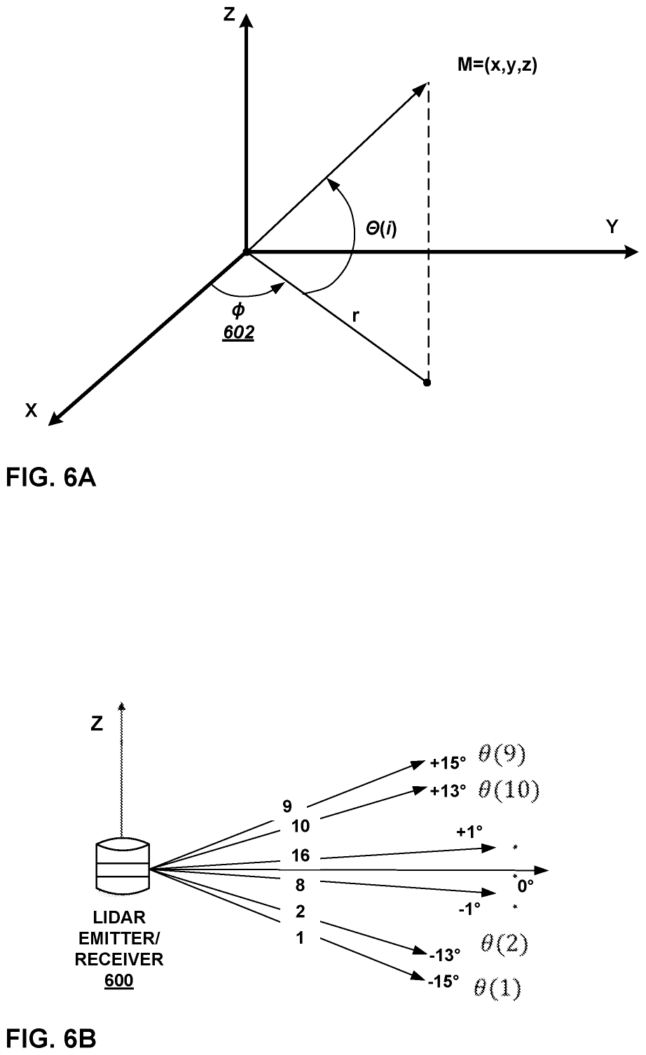

FIGS. 6A and 6B are conceptual diagrams illustrating an example of a spinning LIDAR acquisition model. The acquisition models, shown FIGS. 6A and 6B, relate to point clouds acquired using a spinning LIDAR model. In the example of FIGS. 6A and 6B, LIDAR emitter/receiver 600 has N lasers (e.g., N=16, 32, 64) spinning around the Z axis according to an azimuth angle ϕ 602. Each laser may have different elevation θ (i)_{i=1 . . . N} and height ζ(i)_{i=1 . . . N}. For example, different lasers may be arranged in LIDAR emitter/receiver 600 at different heights. Suppose that the laser i hits a point M, with cartesian integer coordinates (x, y, z), defined according to the coordinate system described in FIG. 6A.

This technique uses three parameters (r, ϕ, i) to represent the position of M, which are computed as follows:

$$r = \sqrt{{x}^{2} + {y}^{2}}$$

$$ϕ = a tan 2 ( y , x )$$

$$i = arg {min}_{j = 1 … N} \{ z + Ϛ ( j ) - r \times tan ( θ ( j ) ) \} ,$$

More precisely, this technique uses the quantized version of (r, ϕ, i), denoted (\tilde{r}, \tilde{ϕ}, i), where the three integers \tilde{r}, \tilde{ϕ} and i are computed as follows:

$$\tilde{r} = floor ( \frac{\sqrt{{x}^{2} + {y}^{2}}}{{q}_{r}} + {o}_{r} ) = hypot ( x , y )$$

$$\tilde{ϕ} = sign ( a tan 2 ( y , x ) ) \times floor ( \frac{\vert a tan 2 ( y , x ) \vert}{{q}_{ϕ}} + {o}_{ϕ} )$$

$$i = arg {min}_{j = 1. .. N} \{ z + Ϛ ( j ) - r \times tan ( θ ( j ) ) \}$$

where
(qᵣ, oᵣ) and (q_{ϕ}, o_{ϕ}) are quantization parameters controlling the precision of \tilde{ϕ} and \tilde{r}, respectively.
sign(t) is the function that return 1 if t is positive and (−1) otherwise.
   |t| is the absolute value of t.

To avoid reconstruction mismatches due to the use of floating-point operations, the values of ζ(i)_{i=1 . . . N} and tan(θ(i))_{i=1 . . . N} are pre-computed and quantized as follows:

$$\tilde{z} ( i ) = sign ( Ϛ ( i ) ) \times floor ( \frac{\vert Ϛ ( i ) \vert}{{q}_{Ϛ}} + {o}_{Ϛ} )$$

$$\tilde{t} ( i ) = sign ( Ϛ ( tan ( θ ( j ) ) ) \times floor ( \frac{\vert tan ( θ ( j ) \vert}{{q}_{θ}} + {o}_{θ} )$$

where
(q_{ζ}, o_{ζ}) and (q_{θ}, o_{θ}) are quantization parameters controlling the precision of \tilde{ζ} and \tilde{θ}, respectively.

The reconstructed cartesian coordinates are obtained as follows:

\hat{x}=round(\tilde{r}×qᵣ×app_cos(\tilde{ϕ}×q_{ϕ}))

ŷ=round(\tilde{r}×qᵣ×app_sin(\tilde{ϕ}×q_{ϕ}))

\hat{z}=round(\tilde{r}×qᵣ×\tilde{t}(i)×q_{θ}−\tilde{z}(i)×q_{ζ}),

where app_cos(.) and app_sin(.) are approximation of cos(.) and sin(.). The calculations could be using a fixed-point representation, a look-up table and linear interpolation.

Note that (\hat{x}, ŷ, \hat{z}) may be different from (x, y, z) due to various reasons which may include quantization, approximations, LIDAR acquisition model imprecision, and/or LIDAR acquisition model parameters imprecisions.

The reconstruction residuals (rₓ, r_{y}, r_{z}) may be defined as follows:

rₓ=x−\hat{X}

r_{y}=y−ŷ

r_{z}=z−\hat{z}

In this technique, G-PCC encoder 200 may perform the following:

1) Encode the LIDAR acquisition model parameters \tilde{t}(i) and \tilde{z}(i) and the quantization parameters qᵣ q_{ζ}, q_{θ} and q_{ϕ};
2) Apply the geometry predictive scheme described in ISO/IEC FDIS 23090-9 Geometry-based Point Cloud Compression, ISO/IEC JTC 1/SC29/WG 7 MDS19617, Teleconference, October 2020, to the representation (\tilde{r}, \tilde{ϕ}, i). In some examples, a new predictor leveraging the characteristics of LIDAR could be introduced. For instance, the rotation speed of the LIDAR scanner around the z-axis is usually constant. Therefore, G-PCC encoder 200 could predict the current \tilde{ϕ}(j) as follows:

\tilde{ϕ}(j)=\tilde{ϕ}(j−1)+n(j)λδ_{ϕ}(k)

Where
i. (δ_{ϕ} (k))_{k=1 . . . K} is a set of potential speeds that G-PCC encoder 200 may choose from. The index k could be explicitly signaled in the bitstream or could be inferred (e.g., by G-PCC decoder 300) from the context based on a deterministic strategy applied by both G-PCC encoder 200 and G-PCC decoder 300, and
ii. n(j) is the number of skipped points which could be explicitly signaled in the bitstream or could be inferred (e.g., by G-PCC decoder 300) from the context based on a deterministic strategy applied by both G-PCC encoder 200 and G-PCC decoder 300. n(j) is also referred to as “phi multiplier” later. Note, n(j) it is currently used only with delta predictor; and
   3) Encode with each node the reconstruction residuals (rₓ, r_{y}, r_{z}).

G-PCC decoder 300 may perform the following:

1) Decode the model parameters \tilde{t}(i) and \tilde{z}(i) and the quantization parameters qᵣ q_{ζ}, q_{θ} and q_{ϕ};
2) Decode the (\tilde{r}, ϕ, i) parameters associated with the nodes according to the geometry predictive scheme described in ISO/IEC FDIS 23090-9 Geometry-based Point Cloud Compression, ISO/IEC JTC 1/SC29/WG 7 MDS19617, Teleconference, October 2020;
3) Compute the reconstructed coordinates (\hat{x}, \tilde{y}, \tilde{z}) as described above;
4) Decode the residuals (rₓ, r_{y}, r_{z}). As discussed in the next section, lossy compression could be supported by quantizing the reconstruction residuals (rₓ, r_{y}, r_{z}); and
5) Compute the original coordinates (x, y, z) as follows:

x=rₓ+\hat{x}

y=r_{y}+ŷ

z=r_{z}+\tilde{z}

Lossy compression could be achieved by applying quantization to the reconstruction residuals (rₓ, r_{y}, r_{z}) or by dropping points.

The quantized reconstruction residuals are computed as follows:

$${\tilde{r}}_{x} = sign ( {r}_{x} ) \times floor ( \frac{\vert {r}_{x} \vert}{{q}_{x}} + {o}_{x} )$$

$${\tilde{r}}_{y} = sign ( {r}_{y} ) \times floor ( \frac{\vert {r}_{y} \vert}{{q}_{y}} + {o}_{y} )$$

$${\tilde{r}}_{z} = sign ( {r}_{z} ) \times floor ( \frac{\vert {r}_{z} \vert}{{q}_{z}} + {o}_{z} )$$

Where (qₓ, oₓ), (q_{y}, o_{y}) and (q_{z}, o_{z}) are quantization parameters controlling the precision of \tilde{r}ₓ, \tilde{r}_{y} and \tilde{r}_{z}, respectively.

Trellis quantization could be used to further improve the RD (rate-distortion) performance results. The quantization parameters may change at sequence/frame/slice/block level to achieve region adaptive quality and for rate control purposes.

G-PCC utilizes the octree-based or predictive-based geometry coding techniques, optionally in combination with prior knowledge about the sensor (e.g., a sensor model), which may be referred to as the angular mode for geometry coding. This prior knowledge (e.g., sensor model) may include angular data and position offsets of multiple lasers within the LIDAR sensor, which may result in significant coding efficiency gains for LIDAR captured point clouds. However, a G-PCC encoder or decoder may have no information available about the 3D scene corresponding with the point cloud. In some examples, a (3D) scene model may be understood as providing a geometrical context (e.g., contextual information) for coding the point cloud. In this regard, it is proposed to utilize a (3D) scene model to improve coding efficiency. According to the techniques of this disclosure, if a scene model (e.g., scene model 230 or scene model 330) is obtained or derived, then this scene model information, alone or together with the sensor model (e.g., sensor model 234 or sensor model 334), could be used to improve the efficiency of coding the point cloud and the point cloud attributes. A point cloud may be defined as a collection of points with positions Xₙ=(xₑ, yₙ, zₙ), n=1, . . . , N, where N is the number of points in the point cloud, and optional attributes Aₙ=(A₁ₙ, A₂ₙ, . . . , A_{Dn}), n=1, . . . , N, where D is the number of attributes for each point. Yet, coding efficiency improvements are dependent on whether the obtained or derived scene model is an accurate representation of the scene which is formed by the point cloud. In this regard, it is recognized that the scene model may be obtained (e.g., received from an external device) or derived for coding a point cloud of a number of frames (e.g., two, three, . . . , ten) or even of one (a single) frame. A scene model may be a digital representation of a real-world scene. For example, a scene model may be mesh-based (including vertices with connectivity information), or other representation of surfaces and objects within a scene, for example, planes representing a grouping of points within defined regions of a point cloud. The techniques of this disclosure may reduce the bandwidth needed to transmit and the memory needed to store the encoded point cloud.

One or more techniques disclosed in this document may be applied independently or in any combination. The techniques of this disclosure may be applicable to encoding and/or decoding of point cloud data.

Determining a sensor model (e.g., sensor model 234 or sensor model 334) that includes intrinsic and/or extrinsic parameters of one or more sensors that are used to acquire the point cloud data is now discussed. The sensors that are modeled may be time of flight (ToF) sensors, such as LIDAR or any sensor that can measure the positions of points in a scene. Examples of intrinsic sensor parameters in the case of LIDAR may include: a number of lasers in the sensor, position(s) of lasers within the sensor head with respect to an origin, angles of the lasers or angle differences of the lasers with respect to a reference, field of view of each laser, number of samples per degree or per turn of the sensor, or sampling rates per laser, etc. Examples of extrinsic sensor parameters may include the position and orientation of the sensors within a scene with respect to a reference.

Determining or obtaining a scene model (e.g., scene model 230 or scene model 330) corresponding with a point cloud is now discussed. In one example of the disclosure, G-PCC encoder 200 or G-PCC decoder 300 may determine or obtain scene model 230 or scene model 330 corresponding with a point cloud of the point cloud data and code the point cloud data based on the scene model. Scene model 230 or scene model 330 may be predetermined or generated or estimated during the coding process of the point cloud. For example, G-PCC encoder 200 or G-PCC decoder 300 may obtain scene model 230 or scene model 330 from an external device. For example, G-PCC encoder 200 or G-PCC decoder 300 may generate or estimate scene model 230 or scene model 330. For example, a scene model may represent the road/ground and/or surrounding objects, such as vehicles, pedestrians, road signs, traffic lights, vegetation, buildings, etc.

In some cases, only the difference between the current frame and the actual scene model (e.g., an obtained scene model) and an estimated scene model may be signaled. For example, for frame N, G-PCC encoder 200 may signal the difference between an obtained scene model 230 and an estimated scene model 230. For example, the difference may be a difference between position coordinates of one or more points in the obtained scene model 230 and the estimated scene model. In some examples, G-PCC encoder 200 or G-PCC decoder 300 may determine an estimated scene model using already decoded information such as previous reconstructed frame(s), e.g., frame (N−1), frame (N−2), etc. G-PCC decoder 300 may parse the signaled difference to determine the difference. For example, G-PCC decoder 300 may use the difference to update scene model 330 or otherwise when decoding the point cloud data. As used herein, parsing is a process of determining a value that is signaled in a bitstream.

In some examples, G-PCC encoder 200 may signal scene model 230 to G-PCC decoder 300 for an intra-frame (or in general random-access frames), and G-PCC encoder 200 may signal the difference between scene model 230 and the current frame to G-PCC decoder 300 for non-intra (non-I) frames (e.g., motion predicted frames) or slices (e.g., motion predicted slices). For example, G-PCC encoder 200 or G-PCC decoder 300 may determine that a frame of the point cloud data is an intra frame and, based on the frame being an intra frame, signal or parse scene model 230 or scene model 330, and use the scene model as a predictor for the current frame of the point cloud data. For example, G-PCC encoder 200 may determine a frame is an intra frame by determining that a frame may be best encoded using intra prediction through an encoding cost analysis. G-PCC decoder 300 may determine whether the frame is an intra frame by decoding syntax information sent by G-PCC encoder 200 to G-PCC decoder 300 indicating that the frame is an intra frame. G-PCC encoder 200 may encode and transmit scene model 230 and G-PCC decoder may decode scene model 230 and store scene model 230 as scene model 330 in memory.

For example, G-PCC encoder 200 or G-PCC decoder 300 may determine that the current frame of the point cloud data is not an intra frame. Based on the frame not being an intra frame (e.g., being an inter frame), G-PCC encoder 200 or G-PCC decoder 300 may determine a difference between an obtained scene model and a determined scene model. Such a difference may include a difference between position points of the obtained scene model and the determined scene model. In some examples, coding the point cloud data is further based on the difference between position points of the obtained scene model and the determined scene model. In some examples, G-PCC decoder 300 may update scene model 300 based on the difference. For example, G-PCC encoder 200 may determine the difference between the obtained scene model and the determined scene model by comparing the obtained scene model and the determined scene model. In some examples, a comparison between the obtained scene model and the determined scene model includes a comparison with regard to the six degrees of freedom a free-moving body has in a 3D space. G-PCC encoder 200 may signal this difference to G-PCC decoder 300. G-PCC decoder 300 may determine the difference between the obtained scene model and the determined scene model by parsing the difference in a bitstream. G-PCC decoder 300 may use the difference to decode the current frame for example, by adding or subtracting the difference from scene model 330 and using the updated scene model 330 as a predictor for the current frame. In some examples, G-PCC encoder 200 or G-PCC decoder 300 may determine scene model 230 or 330, respectively, based on a previous frame.

In some examples, there may be one or multiple scene models associated with a point cloud. For example, scene model 230 and scene model 330 may include multiple scene models. In some examples, scene model 230 or scene model 330 may represent the entire point cloud or represent specific regions of the point cloud. For example, for an automotive use case, a point cloud may represent the road/ground and surrounding objects such as vehicles, pedestrians, road signs, traffic lights, vegetation, buildings, etc. In some examples, a scene model, such as scene model 230 or scene model 330 may be limited to representing the road/ground region or other fixed objects in the scene. In some examples, scene model 230 or scene model 330 may represent a city or a city block. In some examples, G-PCC encoder 200 may segment the point cloud frame into multiple slices, where one or more slices may correspond to road/ground region and remaining slices may represent the remaining scenes of the point cloud frame. For example, G-PCC encoder 200 or G-PCC decoder 300 may classify road points based on a histogram thresholding (T1, T2). See for example, U.S. Provisional Patent Application 63/131,637 filed on Dec. 29, 2020, the entire content of which is incorporated by reference. For example, the histogram may include collected heights (z-values) of point cloud data. G-PCC encoder 200 may calculate thresholds T₁ and T₂ using the histogram. For example, if T₁≤z≤T₂, then a point belongs to a road. In some examples, subsequently, a scene model, such as scene model 230 or scene model 330 may only be applied for the slices associated with road/ground regions. For example, G-PCC encoder 200 or G-PCC decoder 300 may only utilize scene model 230 or scene model 330 when coding the slices associated with road/ground regions. G-PCC encoder 200 may signal a slice level flag to G-PCC decoder 300 to indicate whether scene model 230 or scene model 330 may be applied or not for a particular slice. For example, the slice level flag may indicate whether scene model 230 or scene model 330 is utilized to code the particular slice or not utilized to code the particular slice. Additional scene models may represent buildings, road signs, etc.

In one example of the disclosure, a scene model, e.g., scene model 230 or scene model 330, may represent an approximation of the point cloud. In some examples, scene model 230 or scene model 330 may divide the point cloud region into individual segments (e.g., segments that are modeled individually). In some examples, the segment models may be planes. In some examples, the segment models may be higher order surface approximations, for example, multivariate polynomial models.

In some examples, scene model 230 or scene model 330 may be derived based on a point cloud frame at both the G-PCC encoder 200 and G-PCC decoder in an identical manner to avoid decoding drift. In other words, scene model 230 and scene model 330 may be identical. In some examples, only G-PCC encoder 200 may derive or determine scene model 230 and encode a representation of scene model 230 in the bitstream, which G-PCC decoder 300 may decode and store in memory 340 as scene model 330. For example, from this bitstream, G-PCC decoder 300 may reconstruct scene model 230 as scene model 330. In some examples, the parameters of scene model 230 or scene model 330 may represent the plane parameters that correspond with the segment models or they may represent the parameters of the higher order surface approximations.

In another example of the disclosure, scene model 230 or scene model 330 may be determined based on two or more point cloud frames. Scene model parameter estimation may be optimized based on points belonging to two or more frames. When two or more frames are used to determine scene model 230 or scene model 330, a registration may be performed of points belonging to different frames so that frames together describe a scene model. For example, G-PCC encoder 200 or G-PCC decoder 300 may determine the scene model for a plurality of frames of the point cloud data. determine a registration of points belonging to two point cloud frames of a plurality of point cloud frames and determine displacement of a registered point between the two point cloud frames. For example, G-PCC encoder 200 or G-PCC decoder 300 may determine corresponding points belonging to two frames of the plurality of frames of the point cloud data. G-PCC encoder 200 or G-PCC decoder 300 may determine a displacement of the corresponding points between the two frames. G-PCC encoder 200 or G-PCC decoder 300 may code the current frame of the point cloud data based on the scene model, for example, by compensating for motion between the two frames based on the displacement.

In such a case, G-PCC encoder 200 or G-PCC decoder 300 may compensate for motion based on the displacement when coding the point cloud data. For example, the angular origin of adjacent frames in a point cloud frame sequence may be the position of the LIDAR system that is attached to a vehicle. This origin is thus moving with the vehicle and hence the displacement of the angular origin from one frame to another may be compensated. In some examples, the information of displacement may be estimated or obtained from external means (e.g., global positioning satellite (GPS) parameters of the vehicle).

Utilizing scene model 230 or scene model 330 to code the point cloud geometry and/or attributes is now discussed. In some examples, G-PCC encoder 200 or G-PCC decoder 300 may use scene model 230 or scene model 330 as a reference to code point cloud positions, for example, differences or deltas in positions, for example, the position differences or deltas may be given in cartesian coordinates or spherical coordinates, or the azimuth, radius, laser ID system, etc. In some examples, scene model 230 or scene model 330 may be used to code the current frame in a set of point cloud frames and/or the scene model may be used to code subsequent frames in the set of frames. In some examples, for predictive geometry coding, one or more candidates based on the scene model may be added to a predictor candidate list. In some examples, for predicting transform-based attribute coding, one or more candidates based on the scene model may be added to the predictor candidate list. The predictor candidate list may be used to select a predictor from the candidate list that may be used by G-PCC encoder 200 or G-PCC decoder 300 to predict the current point cloud frame or slice.

G-PCC encoder 200 or G-PCC decoder 300 utilizing the scene model (e.g., scene model 230 or scene model 330) together with the sensor model (e.g., sensor model 234 or sensor model 334) to code the point cloud geometry and/or attributes is now discussed. In some examples, utilizing sensor model 234 or sensor model 334 in conjunction with scene model 230 or scene model 330 may provide estimates of the positions of the points in the point cloud. For example, G-PCC encoder 200 or G-PCC decoder 300 may determine estimates of positions in a point cloud based on sensor model 234 or sensor model 334 and scene model 230 or scene model 330. In such an example, G-PCC encoder 200 or G-PCC decoder 300 may use the estimates of the positions of points in the point cloud as predictors and compute position residuals based on the predictors. In one example, in case of the LIDAR sensor model, the intrinsic and extrinsic sensor parameters may be employed to compute the intersection of the lasers with scene model 230 or scene model 330, which may determine point positions. These point positions may be employed as predictors to code the point cloud. The predictors may be used to compute position residuals, for example, in cartesian coordinates, spherical coordinates, or in the azimuth, radius, laser ID system, etc. For example, G-PCC encoder 200 or G-PCC decoder 300 may determine or compute first intersections of lasers with scene model 230 or scene model 330 based on intrinsic and extrinsic sensor parameters. G-PCC encoder 200 or G-PCC decoder 300 may use the intersections as predictors and compute position residuals based on the predictors when coding the point cloud data.

In some examples, the point cloud may be of a current frame in a set of point cloud frames. In some examples, the point cloud may be of a current frame in a set of point cloud frames in coding order. In one example, to code the current frame, the sensor is repositioned with respect to scene model 230 or scene model 330 of a previous frame based on motion information, for example, motion of the vehicle, which may be estimated or obtained from GPS data. Based on the new position of the sensor and using sensor model 234 or sensor model 334, the intersection of the lasers with scene model 230 or scene model 330 may be computed in order to estimate the point cloud corresponding with the point cloud in the current frame. For example, G-PCC encoder 200 or G-PCC decoder 300 may obtain motion information from GPS data and reposition a sensor, for the current frame, with respect to scene model 230 or scene model 330 based on the motion information.

For a first laser point that is obtained as an intersection of a laser from the sensor at the new position and sensor model 234 or sensor model 334, G-PCC encoder 200 may signal a flag to indicate to G-PCC decoder 300 whether the point is used as a predictor in a subsequent frame.

G-PCC encoder 200 or G-PCC decoder 300 scene modeling of LIDAR point clouds with planes (e.g., an automotive use case) is now discussed. For example, G-PCC encoder 200 or G-PCC decoder 300 may classify road points based on a histogram thresholding (T1, T2). For example, the histogram may include collected heights (z-values) of point cloud data. G-PCC encoder 200 may calculate thresholds T₁ and T₂ using the histogram. For example, if T₁≤z≤T₂, then a point belongs to a road. G-PCC encoder 200 or G-PCC decoder 300 may segment the road region and estimate separate plane parameters for each segment. For example, a segment may be determined by azimuth range and laser index range. G-PCC encoder 200 or G-PCC decoder 300 may use LIDAR parameters (laser angles, vertical offsets) to compute theoretical locations of laser circles (e.g., the circles made by the lasers that are spinning). G-PCC encoder 200 or G-PCC decoder 300 may determine or compute first intersections of laser rays with segment planes. For prediction of subsequent point cloud frames, G-PCC encoder 200 or G-PCC decoder 300 may reposition LIDAR sensor with respect to the road model and determine or compute second intersections of laser rays with segment planes.

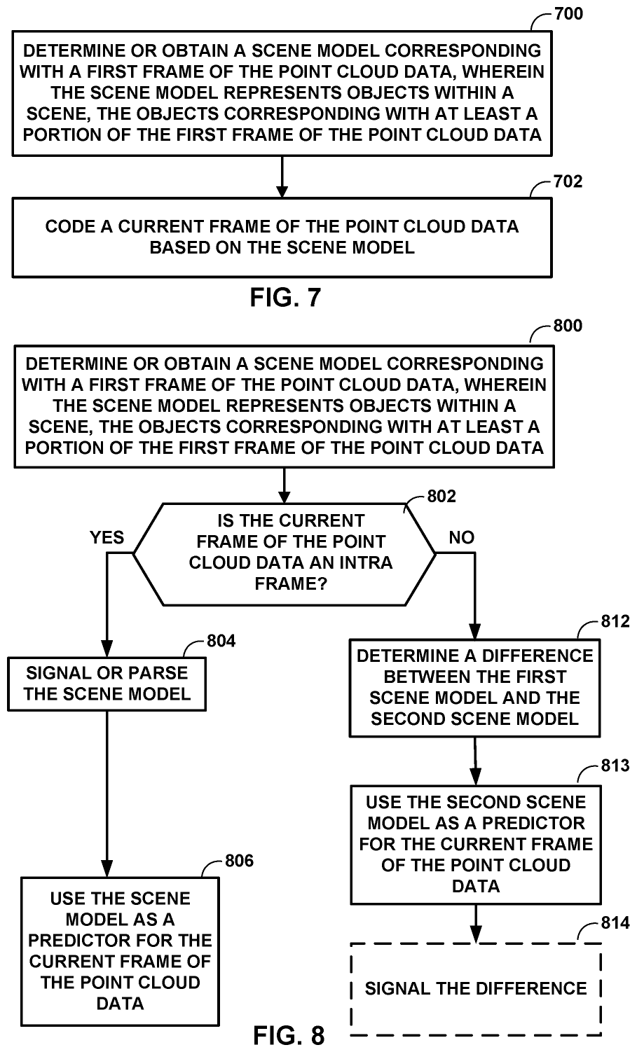

FIG. 7 is a flow diagram illustrating an example of scene model coding techniques according to this disclosure. G-PCC encoder 200 or G-PCC decoder 300 may determine or obtain a scene model corresponding with a first frame of the point cloud data, wherein the scene model represents objects within a scene, the objects corresponding with at least a portion of the first frame of the point cloud data (700). For example, G-PCC encoder 200 may generate or obtain scene model 230 for a scene for which point cloud data is to be encoded. In some examples, G-PCC encoder 200 may obtain scene model 230 by reading scene model 230 from memory 240 or by receiving scene model 230 from an external device. In some examples, scene model 230 is predetermined. In some examples, G-PCC encoder 200 may determine scene model 230 based on a previous frame. A determined scene model may also be referred to as an estimated scene model. In some examples, G-PCC decoder 300 may generate or obtain scene model 330 for a scene for which point cloud data is to be decoded. In some examples, G-PCC decoder 300 may obtain scene model 330 by reading scene model 330 from memory 340 or by receiving scene model 330 from an external device, such as G-PCC encoder 200. In some examples, G-PCC decoder 300 may determine scene model 330 based on a previous frame. G-PCC encoder 200 or G-PCC decoder 300 may code a current frame of the point cloud data based on the scene model (702). For example, G-PCC encoder 200 may encode the current frame of the point cloud data based on scene model 230. For example, G-PCC decoder 300 may decode the current frame of the point cloud data based on scene model 330.

In some examples, the scene model (e.g., scene model 230 or scene model 330) comprises a digital representation of a real-world scene. In some examples, the scene model represents at least one of a road, ground, a vehicle, a pedestrian, a road sign, a traffic light, vegetation, or a building. In some examples, the scene model represents an approximation of the current frame of the point cloud data.

In some examples, the scene model comprises a plurality of individual segments. In some examples, the plurality of individual segments comprises a plurality of planes or a plurality of higher order surface approximations.

In some examples, the first frame is the current frame and G-PCC encoder 200 or G-PCC decoder 300 may determine that the current frame of the point cloud data is an intra frame and, based on the current frame of the point cloud data being the intra frame, signal or parse scene model 230 or scene model 330; and use the scene model as a predictor for the current frame of the point cloud data.

In some examples, coding comprises encoding and determining or obtaining a scene model comprises obtaining a first scene model and determining a second scene model. In such examples, G-PCC encoder 200 may determine that the current frame of the point cloud data is not an intra frame. G-PCC encoder 200 may, based on the current frame of the point cloud data not being the intra frame, determine a difference between the first scene model and the second scene model. G-PCC encoder 200 may use the second scene model as a predictor for the current frame of the point cloud data and signal the difference.

In some examples, G-PCC encoder 200 or G-PCC decoder 300 may signal or parse (respectively) a slice level flag indicative of whether the scene model is utilized for the coding of a particular slice of a plurality of slices of the current frame of the point cloud data. In some examples, G-PCC encoder 200 or G-PCC decoder 300 may determine the scene model including determining the scene model for a plurality of frames of the point cloud data. In some examples, G-PCC encoder 200 or G-PCC decoder 300 may determine corresponding points belonging to two frames of the plurality of frames of the point cloud data. In some examples, G-PCC encoder 200 or G-PCC decoder 300 may determine a displacement of the corresponding points between the two frames. In some examples, G-PCC encoder 200 or G-PCC decoder 300 may code the current frame of the point cloud data based on the scene model including compensating for motion between the two frames based on the displacement.

In some examples, G-PCC encoder 200 or G-PCC decoder 300 may code the current frame of the point cloud data based on the scene model including using the scene model as a reference to code point cloud positions.

In some examples, G-PCC encoder 200 or G-PCC decoder 300 may code using predictive geometry coding or transform-based attribute coding. In some examples, G-PCC encoder 200 or G-PCC decoder 300 may, based on the scene model (e.g., scene model 230 or scene model 330), add one or more candidates to a predictor candidate list and select a candidate from the predictor candidate list. In some examples, G-PCC encoder 200 or G-PCC decoder 300 may code the current frame of the point cloud data including coding the current frame based on the selected candidate.

In some examples, G-PCC encoder 200 or G-PCC decoder 300 may determine estimates of positions of points in the current frame of the point cloud data based on a sensor model (e.g., sensor model 234 or sensor model 334) and the scene model (e.g., scene model 230 or scene model 330). In some examples, G-PCC encoder 200 or G-PCC decoder 300 may code the current frame of the point cloud data based on the scene model including using the estimates of the positions of points in the current frame of the point cloud data as predictors; and computing position residuals based on the predictors. In some examples, the sensor model is representative of LIDAR (Light Detection and Ranging) sensors. In some examples, G-PCC encoder 200 or G-PCC decoder 300 may determine the estimates of the positions of the points including determining first intersections of lasers of the sensor model with the scene model based on intrinsic and extrinsic sensor parameters of the sensor model, and use the estimates of the positions of the points in the point cloud as the predictors including using the first intersections as the predictors.

In some examples, G-PCC encoder 200 or G-PCC decoder 300 may obtain motion information from Global Positioning System data. In some examples, G-PCC encoder 200 or G-PCC decoder 300 may compensate for motion between two frames of the point cloud data comprising repositioning a sensor of the sensor model with respect to the scene model based on the motion information including repositioning a sensor of the sensor model with respect to the scene model based on the motion information. In some examples, G-PCC encoder 200 or G-PCC decoder 300 may, based on a new position of the sensor associated with the repositioning, and based on the sensor model, determine second intersections of lasers with the scene model. In some examples, G-PCC encoder 200 or G-PCC decoder 300 may, based on the second intersections of the lasers with the scene model, predict a point cloud corresponding with a subsequent frame of the two frames of the point cloud data.

In some examples, G-PCC encoder 200 or G-PCC decoder 300 may transmit or receive (respectively) the scene model in a bitstream. In some examples, G-PCC encoder 200 or G-PCC decoder 300 may refrain from transmitting or receiving (respectively) the scene model in a bitstream.

FIG. 8 is a flow diagram illustrating an example of scene model techniques according to this disclosure. G-PCC encoder 200 or G-PCC decoder 300 may determine or obtain a scene model corresponding with a first frame of the point cloud data, wherein the scene model represents objects within a scene, the objects corresponding with at least a portion of the first frame of the point cloud data (800). For example, G-PCC encoder 200 may generate or obtain scene model 230 for a scene for which point cloud data is to be encoded. In some examples, G-PCC encoder 200 may obtain scene model 230 by reading scene model 230 from memory 240 or by receiving scene model 230 from an external device. In some examples, scene model 230 is predetermined. In some examples, G-PCC encoder 200 may determine scene model 230. For example, G-PCC encoder 200 may determine scene model 230 based on a previous frame. In some examples, G-PCC decoder 300 may generate or obtain scene model 330 for a scene for which point cloud data is to be decoded. In some examples, G-PCC decoder 300 may obtain scene model 330 by reading scene model 330 from memory 340 or by receiving scene model 330 from an external device. In some examples, G-PCC decoder 300 may receive scene model 330 from G-PCC encoder 200. In some examples, G-PCC decoder 300 may determine scene model 330. For example, G-PCC decoder 300 may determine scene model 330 based on a previous frame.

G-PCC encoder 200 or G-PCC decoder 300 may determine whether a frame of the point cloud is an intra frame (802). For example, G-PCC encoder 200 may determine that a frame of the point cloud data should or should not be coded as an intra frame. G-PCC encoder 200 may code a syntax element indicative of whether the frame is an intra frame and may signal the syntax element to G-PCC decoder 300 in a bitstream. G-PCC decoder 300 may parse the syntax element from the bitstream to determine whether the frame is an intra frame.

If the frame is an intra frame (the “YES” path from box 802), based on the frame being an intra frame, G-PCC encoder 200 may signal or G-PCC decoder 300 may parse scene model 230 or scene model 330 (804). G-PCC encoder 200 or G-PCC decoder 300 may use the scene model as a predictor for the current frame of the point cloud data (806). For example, G-PCC. For example, G-PCC encoder 200 may encode the current frame of the point cloud data based on scene model 230. For example, G-PCC decoder 300 may decode the current frame of the point cloud data based on scene model 330. In some examples, the first frame is the current frame.

If the frame is not an intra frame (e.g., the frame is an inter frame) (the “NO” path from box 802), G-PCC encoder 200 or G-PCC decoder 300 may determine a difference between a first scene model and a second scene model (812). For example, G-PCC encoder 200 may determine points between the first scene model (which may be an obtained scene model) and the second scene model (which may be a determined scene model) are moved, and this movement may be the difference between the position coordinates of the points. In some examples, the first frame is a previous frame is the second scene model. G-PCC encoder 200 or G-PCC decoder 300 may use the second scene model as a predictor for the current frame of the point cloud data (813). In the example, where G-PCC decoder 300 uses the second scene model as a predictor for the current frame of the point cloud data, G-PCC encoder 200 may signal the difference (814). For example, G-PCC encoder 200 may signal a syntax element indicative of the difference and G-PCC decoder 300 may parse the syntax element to determine the difference. G-PCC decoder 300 may use the difference to update scene model 330 to the second scene model and use the second scene model as the predictor for the current frame of the point cloud data.

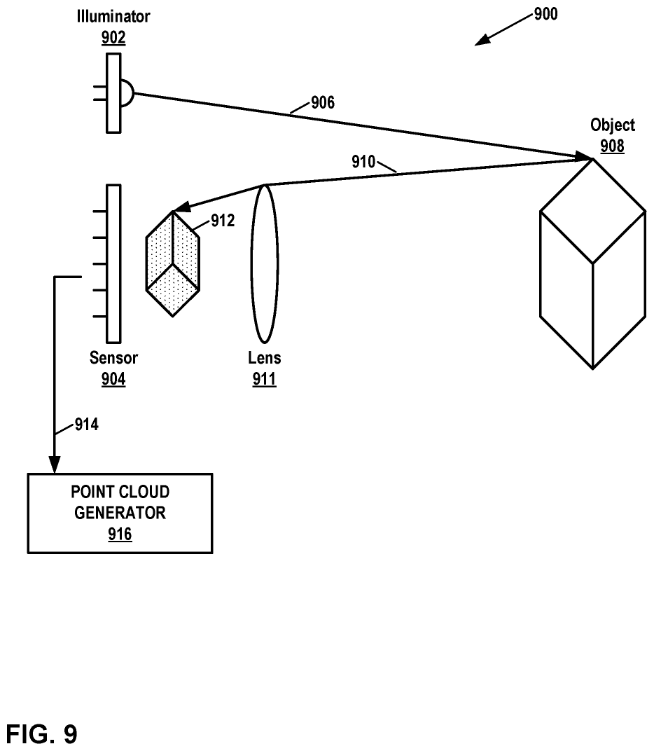

FIG. 9 is a conceptual diagram illustrating an example range-finding system 900 that may be used with one or more techniques of this disclosure. In the example of FIG. 9, range-finding system 900 includes an illuminator 902 and a sensor 904. Illuminator 902 may emit light 906. In some examples, illuminator 902 may emit light 906 as one or more laser beams. Light 906 may be in one or more wavelengths, such as an infrared wavelength or a visible light wavelength. In other examples, light 906 is not a coherent, laser light. When light 906 encounters an object, such as object 908, light 906 creates returning light 910. Returning light 910 may include backscattered and/or reflected light. Returning light 910 may pass through a lens 911 that directs returning light 910 to create an image 912 of object 908 on sensor 904. Sensor 904 generates signals 914 based on image 912. Image 912 may comprise a set of points (e.g., as represented by dots in image 912 of FIG. 8).

In some examples, illuminator 902 and sensor 904 may be mounted on a spinning structure so that illuminator 902 and sensor 904 capture a 360-degree view of an environment. In other examples, range-finding system 900 may include one or more optical components (e.g., mirrors, collimators, diffraction gratings, etc.) that enable illuminator 902 and sensor 904 to detect ranges of objects within a specific range (e.g., up to 360-degrees). Although the example of FIG. 9 only shows a single illuminator 902 and sensor 904, range-finding system 900 may include multiple sets of illuminators and sensors.

In some examples, illuminator 902 generates a structured light pattern. In such examples, range-finding system 900 may include multiple sensors 904 upon which respective images of the structured light pattern are formed. Range-finding system 900 may use disparities between the images of the structured light pattern to determine a distance to an object 908 from which the structured light pattern backscatters. Structured light-based range-finding systems may have a high level of accuracy (e.g., accuracy in the sub-millimeter range), when object 908 is relatively close to sensor 904 (e.g., 0.2 meters to 2 meters). This high level of accuracy may be useful in facial recognition applications, such as unlocking mobile devices (e.g., mobile phones, tablet computers, etc.) and for security applications.

In some examples, range-finding system 900 is a ToF-based system. In some examples where range-finding system 900 is a ToF-based system, illuminator 902 generates pulses of light. In other words, illuminator 902 may modulate the amplitude of emitted light 906. In such examples, sensor 904 detects returning light 910 from the pulses of light 906 generated by illuminator 902. Range-finding system 900 may then determine a distance to object 908 from which light 906 backscatters based on a delay between when light 906 was emitted and detected and the known speed of light in air). In some examples, rather than (or in addition to) modulating the amplitude of the emitted light 906, illuminator 902 may modulate the phase of the emitted light 906. In such examples, sensor 904 may detect the phase of returning light 910 from object 908 and determine distances to points on object 908 using the speed of light and based on time differences between when illuminator 902 generated light 906 at a specific phase and when sensor 904 detected returning light 910 at the specific phase.

In other examples, a point cloud may be generated without using illuminator 902. For instance, in some examples, sensors 904 of range-finding system 900 may include two or more optical cameras. In such examples, range-finding system 900 may use the optical cameras to capture stereo images of the environment, including object 908. Range-finding system 900 may include a point cloud generator 916 that may calculate the disparities between locations in the stereo images. Range-finding system 900 may then use the disparities to determine distances to the locations shown in the stereo images. From these distances, point cloud generator 916 may generate a point cloud.

Sensors 904 may also detect other attributes of object 908, such as color and reflectance information. In the example of FIG. 9, a point cloud generator 916 may generate a point cloud based on signals 914 generated by sensor 904. Range-finding system 900 and/or point cloud generator 916 may form part of data source 104 (FIG. 1). Hence, a point cloud generated by range-finding system 900 may be encoded and/or decoded according to any of the techniques of this disclosure.

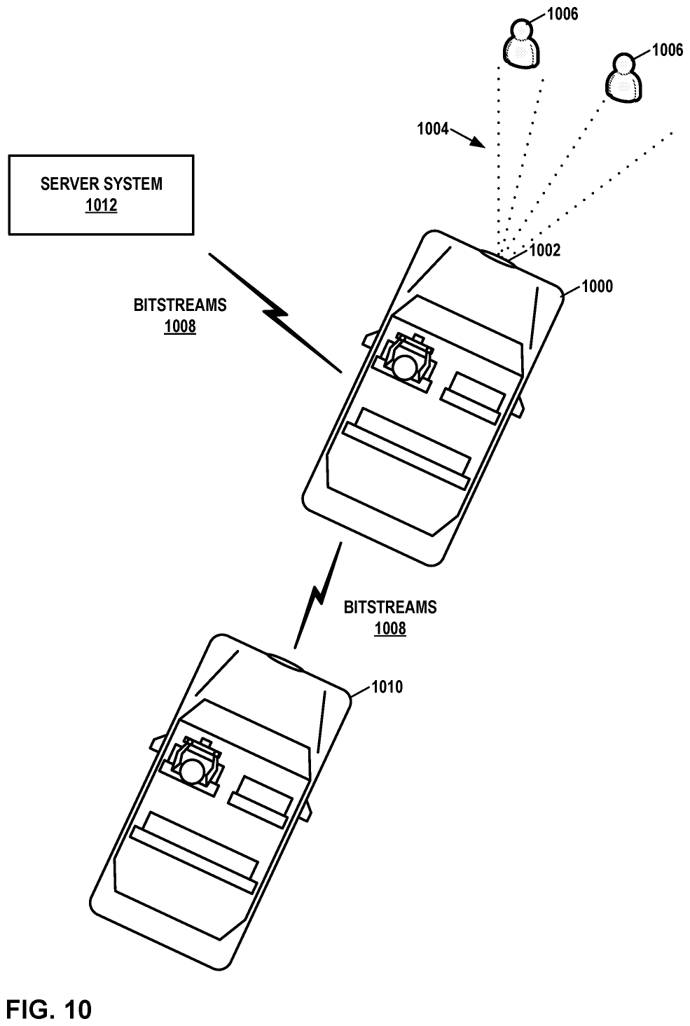

FIG. 10 is a conceptual diagram illustrating an example vehicle-based scenario in which one or more techniques of this disclosure may be used. In the example of FIG. 10, a vehicle 1000 includes a range-finding system 1002. Range-finding system 1002 may be implemented in the manner discussed with respect to FIG. 10. Although not shown in the example of FIG. 10, vehicle 1000 may also include a data source, such as data source 104 (FIG. 1), and a G-PCC encoder, such as G-PCC encoder 200 (FIG. 1). In the example of FIG. 10, range-finding system 1002 emits laser beams 1004 that reflect off pedestrians 1006 or other objects in a roadway. The data source of vehicle 1000 may generate a point cloud based on signals generated by range-finding system 1002. The G-PCC encoder of vehicle 1000 may encode the point cloud to generate bitstreams 1008, such as geometry bitstream (FIG. 2) and attribute bitstream (FIG. 2). Bitstreams 1008 may include many fewer bits than the unencoded point cloud obtained by the G-PCC encoder. In some examples, the G-PCC encoder of vehicle 1000 may encode the bitstreams 1008 using one or more actual scene models, estimated scene models, and/or sensor models as described above.

An output interface of vehicle 1000 (e.g., output interface 108 (FIG. 1) may transmit bitstreams 1008 to one or more other devices. Bitstreams 1008 may include many fewer bits than the unencoded point cloud obtained by the G-PCC encoder. Thus, vehicle 1000 may be able to transmit bitstreams 1008 to other devices more quickly than the unencoded point cloud data. Additionally, bitstreams 1008 may require less data storage capacity.

In the example of FIG. 10, vehicle 1000 may transmit bitstreams 1008 to another vehicle 1010. Vehicle 1010 may include a G-PCC decoder, such as G-PCC decoder 300 (FIG. 1). The G-PCC decoder of vehicle 1010 may decode bitstreams 1008 to reconstruct the point cloud. In some examples, the G-PCC decoder of vehicle 1010 may use one or more actual scene models, estimated scene models, and/or sensor models as described above, when decoding the point cloud. Vehicle 1010 may use the reconstructed point cloud for various purposes. For instance, vehicle 1010 may determine based on the reconstructed point cloud that pedestrians 1006 are in the roadway ahead of vehicle 1000 and therefore start slowing down, e.g., even before a driver of vehicle 1010 realizes that pedestrians 1006 are in the roadway. Thus, in some examples, vehicle 1010 may perform an autonomous navigation operation based on the reconstructed point cloud.

Additionally or alternatively, vehicle 1000 may transmit bitstreams 1008 to a server system 1012. Server system 1012 may use bitstreams 1008 for various purposes. For example, server system 1012 may store bitstreams 1008 for subsequent reconstruction of the point clouds. In this example, server system 1012 may use the point clouds along with other data (e.g., vehicle telemetry data generated by vehicle 1000) to train an autonomous driving system. In other example, server system 1012 may store bitstreams 1008 for subsequent reconstruction for forensic crash investigations.

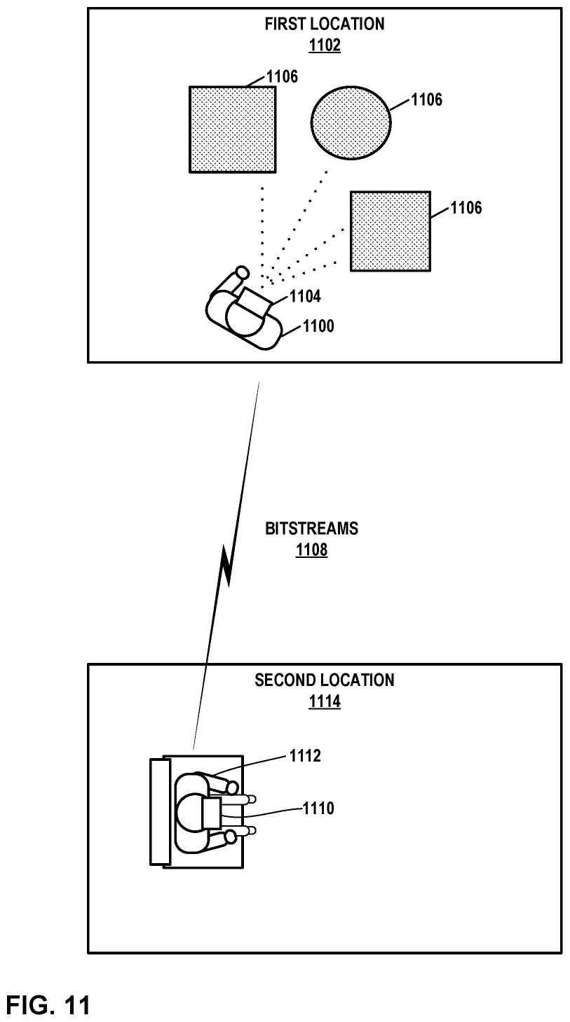

FIG. 11 is a conceptual diagram illustrating an example extended reality system in which one or more techniques of this disclosure may be used. Extended reality (XR) is a term used to cover a range of technologies that includes augmented reality (AR), mixed reality (MR), and virtual reality (VR). In the example of FIG. 11, a user 1100 is located in a first location 1102. User 1100 wears an XR headset 1104. As an alternative to XR headset 1104, user 1100 may use a mobile device (e.g., mobile phone, tablet computer, etc.). XR headset 1104 includes a depth detection sensor, such as a range-finding system, that detects positions of points on objects 1106 at location 1102. A data source of XR headset 1104 may use the signals generated by the depth detection sensor to generate a point cloud representation of objects 1106 at location 1102. XR headset 1104 may include a G-PCC encoder (e.g., G-PCC encoder 200 of FIG. 1) that is configured to encode the point cloud to generate bitstreams 1108. In some examples, the G-PCC encoder of XR headset 1104 may use actual scene models, estimated scene models, and/or sensor models when encoding the point cloud, as described above.

XR headset 1104 may transmit bitstreams 1108 (e.g., via a network such as the Internet) to an XR headset 1110 worn by a user 1112 at a second location 1114. XR headset 1110 may decode bitstreams 1108 to reconstruct the point cloud. In some examples, the G-PCC decoder of XR headset 1110 may use actual scene models, estimated scene models, and/or sensor models when decoding the point cloud, as described above.

XR headset 1110 may use the point cloud to generate an XR visualization (e.g., an AR, MR, VR visualization) representing objects 1106 at location 1102. Thus, in some examples, such as when XR headset 1110 generates an VR visualization, user 1112 may have a 3D immersive experience of location 1102. In some examples, XR headset 1110 may determine a position of a virtual object based on the reconstructed point cloud. For instance, XR headset 1110 may determine, based on the reconstructed point cloud, that an environment (e.g., location 1102) includes a flat surface and then determine that a virtual object (e.g., a cartoon character) is to be positioned on the flat surface. XR headset 1110 may generate an XR visualization in which the virtual object is at the determined position. For instance, XR headset 1110 may show the cartoon character sitting on the flat surface.

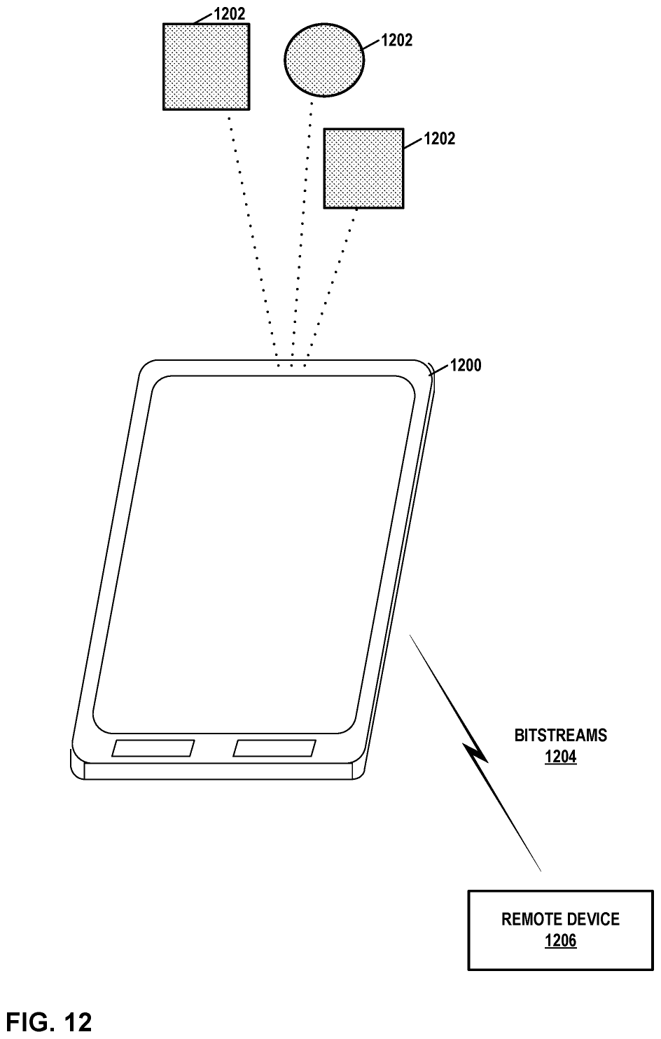

FIG. 12 is a conceptual diagram illustrating an example mobile device system in which one or more techniques of this disclosure may be used. In the example of FIG. 12, a mobile device 1200, such as a mobile phone or tablet computer, includes a range-finding system, such as a LIDAR system, that detects positions of points on objects 1202 in an environment of mobile device 1200. A data source of mobile device 1200 may use the signals generated by the depth detection sensor to generate a point cloud representation of objects 1202. Mobile device 1200 may include a G-PCC encoder (e.g., G-PCC encoder 200 of FIG. 1) that is configured to encode the point cloud to generate bitstreams 1204. In some examples, the G-PCC encoder of mobile device 1200 may use actual scene models, estimated scene models, and/or sensor models when encoding the point cloud, as described above.

In the example of FIG. 12, mobile device 1200 may transmit bitstreams to a remote device 1206, such as a server system or other mobile device. Remote device 1206 may decode bitstreams 1204 to reconstruct the point cloud. In some examples, the G-PCC decoder of remote device 1206 may use actual scene models, estimated scene models, and/or sensor models when decoding the point cloud, as described above.

Remote device 1206 may use the point cloud for various purposes. For example, remote device 1206 may use the point cloud to generate a map of environment of mobile device 1200. For instance, remote device 1206 may generate a map of an interior of a building based on the reconstructed point cloud. In another example, remote device 1206 may generate imagery (e.g., computer graphics) based on the point cloud. For instance, remote device 1206 may use points of the point cloud as vertices of polygons and use color attributes of the points as the basis for shading the polygons. In some examples, remote device 1206 may use the reconstructed point cloud for facial recognition or other security applications.

This disclosure contains the following non-limiting clauses.

Clause 1A. A method of coding point cloud data, the method comprising: determining a sensor model comprising at least one intrinsic or extrinsic parameters of one or more sensors configured to acquire the point cloud data; and coding the point cloud data based on the sensor model.

Clause 2A. The method of clause 1A, wherein the one or more sensors are further configured to sense positions of points in a scene.

Clause 3A. The method of clause 1A or clause 2A, wherein the one or more sensors comprise one or more LIDAR (Light Detection and Ranging) sensors.

Clause 4A. The method of any combination of clauses 1A-3A, wherein the sensor model comprises at least one of a number of lasers in a sensor, a position of the lasers in the sensor with respect to an origin, angles of the lasers in the sensor, angle differences of the lasers in the sensor with respect to a reference, a field of view of each laser of the sensor, number of samples per degree of the sensor, number of samples per turn of the sensor, or sampling rates of each laser of the sensor.

Clause 5A. The method of any combination of clauses 1A-3A, wherein the sensor model comprises at least one of a position of a sensor within a scene with respect to a reference or an orientation of the sensor within the scene with respect to the reference.

Clause 6A. A method of coding point cloud data, the method comprising: determining a scene model corresponding with a point cloud of the point cloud data; and coding the point cloud data based on the scene model.

Clause 7A. The method of clause 6A, wherein determining the scene model comprises reading a predetermined scene model from memory.

Clause 8A. The method of clause 6A, wherein determining the scene model comprises generating or estimating the scene model.

Clause 9A. The method of any of clauses 6A-8A, further comprising: determining a difference between the scene model and an estimated scene model; and signaling or parsing the difference.

Clause 10A. The method of any of clauses 6A-9A, further comprising: determining whether a frame is an intra frame; and based on the frame being an intra frame, signaling or parsing the scene model.

Clause 11A. The method of clause 10A, wherein the frame is a first frame, further comprising: determining whether a second frame is an intra frame; and based on the second frame not being an intra frame, determining a difference between the scene model for the second frame and an estimated scene model for the second frame; and signaling or parsing the difference.

Clause 12A. The method of any of clauses 6A-11A, wherein the scene model is one of a plurality of scene models.

Clause 13A. The method of any of clauses 6A-12A, wherein the scene model represents an entire point cloud.

Clause 14A. The method of any of clauses 6A-12A, wherein the scene model represents a region of a point cloud.

Clause 15A. The method of clause 14A, wherein the scene model represents at least one of a road, ground, an automobile, a person, a road sign, vegetation, or a building.

Clause 16A. The method of any of clauses 6A-15A, further comprising: segmenting a point cloud frame in a plurality of slices, wherein one or more of the plurality of slices correspond to a road region; and applying the scene model applied for the one or more of the plurality of slices corresponding to the road region.

Clause 17A. The method of clause 16A, further comprising: signaling or parsing a slice level flag indicative of whether the scene model is applied for a slice of the plurality of slices.

Clause 18A. The method of any of clauses 6A-17A, wherein the scene model represents an approximation of the point cloud.

Clause 19A. The method of any of clauses 6A-18A, wherein the scene model comprises a plurality of segments that are modelled individually.

Clause 20A. The method of clause 19A, wherein the segments comprise planes.

Clause 21A. The method of clause 19A, wherein the segments comprise higher order surface approximations.

Clause 22A. The method of clause 21A, wherein the higher order surface approximations comprise multivariate polynomial models.

Clause 23A. The method of any of clauses 6A-22A, wherein the method is performed by both a G-PCC encoder and a G-PCC decoder.

Clause 24A. The method of any of clauses 6A-23A, wherein the method is performed by a G-PCC encoder and coding comprises encoding, further comprising: encoding, in a bitstream, a representation of the scene model.

Clause 25A. The method of any of clauses 6A-24A, where the method is performed by a G-PCC decoder and coding comprises decoding, and wherein the determining the scene model comprises parsing a representation of the scene model in a bitstream.

Clause 26A. The method of any of clauses 6A-25A, wherein the scene model is determined based on a plurality of point cloud frames.

Clause 27A. The method of clause 26A, further comprising: determining a registration of points belonging to different point cloud frames of the plurality of point cloud frames.

Clause 28A. The method of clause 27A, further comprising: determining displacement of a point between two of the plurality of point cloud frames.

Clause 29A. The method of any of clauses 6A-28A, wherein coding the point cloud data based on the scene model comprises: using the scene model as a reference to code point cloud positions.

Clause 30A. The method of clause 29A, wherein the reference comprises differences in position coordinates.

Clause 31A. The method of clause 30A, wherein the position coordinates comprise one or more of cartesian coordinates, spherical coordinates, an azimuth, a radius, or a laser ID system.

Clause 32A. The method of any of clauses 6A-31A, wherein coding the point cloud data based on the scene model comprises at least one of: coding a current frame in a set of point cloud frames; or coding a subsequent frame in the set of point cloud frames.

Clause 33A. The method of any of clauses 6A-32A, wherein coding comprises predictive geometry coding, the method further comprising: based on scene model, adding one or more candidates to a predictor candidate list.

Clause 34A. The method of any of clauses 6A-33A, wherein coding comprises transform-based attribute coding, the method further comprising: based on scene model, adding one or more candidates to a predictor candidate list.

Clause 35A. The method of a combination of clause 1A and clause 5A, further comprising: determining estimates of positions of points in a point cloud based on the sensor model and the scene model.

Clause 36A. The method of clause 35A, wherein the determining estimates of positions of points comprises: computing intersections of lasers with the scene model based on intrinsic and extrinsic sensor parameters

Clause 37A. The method of clause 36A, further comprising: using the intersections as predictors to code the point cloud.

Clause 38A. The method of clause 37A, further comprising: computing position residuals based on the predictors.

Clause 39A. The method of clause 38A, wherein the position residuals comprise at least one of cartesian coordinates, spherical coordinates, an azimuth, a radius, of a laser ID system.

Clause 40A. The method of any of clauses 35A-39A, further comprising: repositioning a sensor, for a subsequent frame, with respect to the scene model based on motion parameters.

Clause 41A. The method of clause 40A, wherein the motion parameters are estimated or obtained from Global Positioning System data.

Clause 42A. The method of clause 40A or 41A, further comprising: based on a new position of the sensor associated with the repositioning, and based on the sensor model, determining an intersection of the lasers with the scene model; and based on the intersection of the lasers with the scene model, predicting a point cloud corresponding with a point cloud in a subsequent frame.

Clause 43A. The method of any of clauses 40A-42A, further comprising: signaling or parsing a flag indicative of whether a point is used as a predictor in a subsequent frame.

Clause 44A. The method of any of clauses 1A-43A, further comprising generating the point cloud.

Clause 45A. A device for processing a point cloud, the device comprising one or more means for performing the method of any of clauses A1-44A.

Clause 46A. The device of clause 45A, wherein the one or more means comprise one or more processors implemented in circuitry.

Clause 47A. The device of any of clauses 45A or 46A, further comprising a memory to store the data representing the point cloud.

Clause 48A. The device of any of clauses 45A-47A, wherein the device comprises a decoder.

Clause 49A. The device of any of clauses 45A-48A, wherein the device comprises an encoder.

Clause 50A. The device of any of clauses 45A-49A, further comprising a device to generate the point cloud.

Clause 51A. The device of any of clauses 45A-50A, further comprising a display to present imagery based on the point cloud.

Clause 52A. A computer-readable storage medium having stored thereon instructions that, when executed, cause one or more processors to perform the method of any of clauses 1A-44A.

Clause 1B. A method of coding point cloud data, the method comprising: determining or obtaining a scene model corresponding with a first frame of the point cloud data, wherein the scene model represents objects within a scene, the objects corresponding with at least a portion of the first frame of the point cloud data; and coding a current frame of the point cloud data based on the scene model.

Clause 2B. The method of clause 1B, wherein the scene model comprises a digital representation of a real-world scene.

Clause 3B. The method of clause 1B or clause 2B, wherein the scene model represents at least one of a road, ground, a vehicle, a pedestrian, a road sign, a traffic light, vegetation, or a building.

Clause 4B. The method of any of clauses 1B-3B, wherein the scene model represents an approximation of the current frame of the point cloud data.

Clause 5B. The method of any of clauses 1B-4B, wherein the scene model comprises a plurality of individual segments.

Clause 6B. The method of clause 5B, wherein the plurality of individual segments comprises a plurality of planes or a plurality of higher order surface approximations.

Clause 7B. The method of any of clauses 1B-6B, wherein the first frame is the current frame, the method further comprising: determining that the current frame of the point cloud data is an intra frame; based on the current frame of the point cloud data being the intra frame, signaling or parsing the scene model; and using the scene model as a predictor for the current frame of the point cloud data.

Clause 8B. The method of any of clauses 1B-6B, wherein coding comprises encoding and determining or obtaining a scene model comprises obtaining a first scene model and determining a second scene model, the method further comprising: determining that the current frame of the point cloud data is not an intra frame; based on the current frame of the point cloud data not being the intra frame, determining a difference between the first scene model and the second scene model; using the second scene model as a predictor for the current frame of the point cloud data; and signaling the difference.

Clause 9B. The method of any of clauses 1B-8B, further comprising: signaling or parsing a slice level flag indicative of whether the scene model is utilized for the coding of a particular slice of a plurality of slices of the current frame of the point cloud data.

Clause 10B. The method of any of clauses 1B-9B, wherein determining the scene model comprises determining the scene model for a plurality of frames of the point cloud data, and wherein the method further comprises: determining corresponding points belonging to two frames of the plurality of frames of the point cloud data; and determining a displacement of the corresponding points between the two frames, wherein coding the current frame of the point cloud data based on the scene model comprises compensating for motion between the two frames based on the displacement.

Clause 11B. The method of any of clauses 1B-10B, wherein the coding the current frame of the point cloud data based on the scene model comprises: using the scene model as a reference to code point cloud positions.

Clause 12B. The method of any of clauses 1B-11B, wherein the coding comprises predictive geometry coding or transform-based attribute coding, the method further comprising: based on the scene model, adding one or more candidates to a predictor candidate list; and selecting a candidate from the predictor candidate list, wherein coding the current frame of the point cloud data comprises coding the current frame based on the selected candidate.

Clause 13B. The method of any of clauses 1B-12B, further comprising: determining estimates of positions of points in the current frame of the point cloud data based on a sensor model and the scene model, wherein coding the current frame of the point cloud data based on the scene model comprises: using the estimates of the positions of points in the current frame of the point cloud data as predictors; and computing position residuals based on the predictors.

Clause 14B. The method of clause 13B, wherein the sensor model is representative of LIDAR (Light Detection and Ranging) sensors, and wherein the determining the estimates of the positions of the points comprises: determining first intersections of lasers of the sensor model with the scene model based on intrinsic and extrinsic sensor parameters of the sensor model, wherein using the estimates of the positions of the points in the point cloud as the predictors comprises using the first intersections as the predictors.

Clause 15B. The method of clause 14B, further comprising: obtaining motion information from Global Positioning System data; compensating for motion between two frames of the point cloud data comprising repositioning a sensor of the sensor model with respect to the scene model based on the motion information; based on a new position of the sensor associated with the repositioning and based on the sensor model, determining second intersections of lasers with the scene model; and based on the second intersections of the lasers with the scene model, predicting a point cloud corresponding with a subsequent frame of the two frames of the point cloud data.

Clause 16B. The method of any of clauses 1B-15B, wherein the method further comprises: transmitting or receiving the scene model in a bitstream.

Clause 17B. The method of any of clauses 1B-15B, wherein the method further comprises: refraining from transmitting or receiving the scene model in a bitstream.

Clause 18B. A device for coding point cloud data, the device comprising: a memory configured to store the point cloud data; and one or more processors implemented in circuitry and communicatively coupled to the memory, the one or more processors being configured to: determine or obtain a scene model corresponding with a first frame of the point cloud data, wherein the scene model represents objects within a scene, the objects corresponding with at least a portion of the first frame of the point cloud data; and code the current frame of the point cloud data based on the scene model.

Clause 19B. The device of clause 18B, wherein the scene model comprises a digital representation of a real-world scene.

Clause 20B. The device of clause 18B or clause 19B, wherein the scene model represents at least one of a road, ground, a vehicle, a pedestrian, a road sign, a traffic light, vegetation, or a building.

Clause 21B. The device of any of clauses 18B-20B, wherein the scene model represents an approximation of the current frame of the point cloud data.

Clause 22B. The device of any of clauses 18B-21B, wherein the scene model comprises a plurality of individual segments.

Clause 23B. The device of clause 22B, wherein the plurality of individual segments comprises a plurality of planes or a plurality of higher order surface approximations.

Clause 24B. The device of any of clauses 18B-23B, wherein the first frame is the current frame, and wherein the one or more processors are further configured to: determine that the current frame of the point cloud data is an intra frame; based on the current frame of the point cloud data being the intra frame, signal or parse the scene model; and use the scene model as a predictor for the current frame of the point cloud data.

Clause 25B. The device of any of clauses 18B-23B, wherein code comprises encode and as part of determining or obtaining the scene model the one or more processors are configured to obtaining a first scene model and determining a second scene model, wherein the one or more processors are further configured to: determine that the current frame of the point cloud data is not an intra frame; based on the current frame of the point cloud data not being the intra frame, determine a difference between the first scene model and the second scene model; use the second scene model as a predictor for the current frame of the point cloud data; and signal the difference.

Clause 26B. The device of any of clauses 18B-25B, wherein the one or more processors are further configured to: signal or parse a slice level flag indicative of whether the scene model is utilized for the coding of a particular slice of a plurality of slices of the current frame of the point cloud data.

Clause 27B. The device of any of clauses 18B-26B, wherein as part of determining the scene model wherein the one or more processors are further configured to determining the scene model for a plurality of frames of the point cloud data, and wherein the one or more processors are further configured to: determine corresponding points belonging to two frames of the plurality of frames of the point cloud data; and determine a displacement of the corresponding points between the two frames, wherein as part of coding the current frame of the point cloud data based on the scene model, the one or more processors are configured to compensate for motion between the two frames based on the displacement.

Clause 28B. The device of any of clauses 18B-27B, wherein as part of coding the current frame of the point cloud data based on the scene model, the one or more processors are configured to use the scene model as a reference to code point cloud positions.

Clause 29B. The device of any of clauses 18B-28B, wherein code comprises predictive geometry code or transform-based attribute code, and wherein the one or more processors are further configured to: based on the scene model, add one or more candidates to a predictor candidate list; and select a candidate from the predictor candidate list, wherein as part of coding the current frame of the point cloud data, the one or more processors are configured to code the current frame based on the selected candidate.

Clause 30B. The device of any of clauses 18B-29B, wherein the one or more processors are further configured to: determine estimates of positions of points in the current frame of the point cloud data based on a sensor model and the scene model, wherein as part of coding the current frame of the point cloud data based on the scene model, the one or more processors are configured to: use the estimates of the positions of points in the current frame of the point cloud data as predictors; and compute position residuals based on the predictors.

Clause 31B. The device of clause 30B, wherein the sensor model is representative of LIDAR (Light Detection and Ranging) sensors, and wherein as part of determining the estimates of the positions of the points, the one or more processors are further configured to: determine first intersections of lasers of the sensor model with the scene model based on intrinsic and extrinsic sensor parameters of the sensor model, wherein as part of using the estimates of the positions of the points in the point cloud as the predictors, the one or more processors are further configured to use the first intersections as the predictors.

Clause 32B. The device of clause 31B, wherein the one or more processors are further configured to: obtain motion information from Global Positioning System data; compensate for motion between two frames of the point cloud data comprising repositioning a sensor of the sensor model with respect to the scene model based on the motion information; based on a new position of the sensor associated with the repositioning, and based on the sensor model, determine second intersections of lasers with the scene model; and based on the second intersections of the lasers with the scene model, predict a point cloud corresponding with a subsequent frame of the two frames of the point cloud data.

Clause 33B. The device of any of clauses 18B-32B, wherein the device comprises a vehicle, a robot, or a smartphone.

Clause 34B. The device of any of clauses 18B-33B, wherein the one or more processors are further configured to: transmit or receive the scene model in a bitstream.

Clause 35B. The device of any of clauses 18B-33B, wherein the one or more processors are further configured to: refrain from transmitting or receiving the scene model in a bitstream.

Clause 36B. A non-transitory computer-readable storage medium having stored thereon instructions that, when executed, cause one or more processors to: determine or obtain a scene model corresponding with a first frame of point cloud data, wherein the scene model represents objects within a scene, the objects corresponding with at least a portion of the first frame of the point cloud data; and code a current frame of the point cloud data based on the scene model.

Clause 37B. A device for coding point cloud data, the device comprising: means for determining or obtaining a scene model corresponding with a first frame of the point cloud data, wherein the scene model represents objects within a scene, the objects corresponding with at least a portion of the first frame of the point cloud data; and means for coding a current frame of the point cloud data based on the scene model.

Examples in the various aspects of this disclosure may be used individually or in any combination.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding point cloud data, the method comprising:
determining or obtaining a scene model corresponding with a first frame of the point cloud data, wherein the scene model represents objects within a scene, the objects corresponding with at least a portion of the first frame of the point cloud data; and
coding a current frame of the point cloud data based on the scene model.

2. The method of claim 1, wherein the scene model comprises a digital representation of a real-world scene.

3. The method of claim 1, wherein the scene model represents at least one of a road, ground, a vehicle, a pedestrian, a road sign, a traffic light, vegetation, or a building.

4. The method of claim 1, wherein the scene model represents an approximation of the point cloud data.

5. The method of claim 1, wherein the scene model comprises a plurality of individual segments.

6. The method of claim 5, wherein the plurality of individual segments comprises a plurality of planes or a plurality of higher order surface approximations.

7. The method of claim 1, wherein the first frame is the current frame, the method further comprising:
determining that the current frame of the point cloud data is an intra frame;
based on the current frame of the point cloud data being the intra frame, signaling or parsing the scene model; and
using the scene model as a predictor for the current frame of the point cloud data.

8. The method of claim 1, wherein coding comprises encoding and determining or obtaining a scene model comprises obtaining a first scene model and determining a second scene model, the method further comprising:
determining that the current frame of the point cloud data is not an intra frame;
based on the current frame of the point cloud data not being the intra frame, determining a difference between the first scene model and the second scene model;
using the second scene model as a predictor for the current frame of the point cloud data; and
signaling the difference.

9. The method of claim 1, further comprising:
signaling or parsing a slice level flag indicative of whether the scene model is utilized for the coding of a particular slice of a plurality of slices of the current frame of the point cloud data.

10. The method of claim 1, wherein determining the scene model comprises determining the scene model for a plurality of frames of the point cloud data, and wherein the method further comprises:
determining corresponding points belonging to two frames of the plurality of frames of the point cloud data; and
determining a displacement of the corresponding points between the two frames,
wherein coding the current frame of the point cloud data based on the scene model comprises compensating for motion between the two frames based on the displacement.

11. The method of claim 1, wherein the coding the current frame of the point cloud data based on the scene model comprises:
using the scene model as a reference to code point cloud positions.

12. The method of claim 1, wherein the coding comprises predictive geometry coding or transform-based attribute coding, the method further comprising:
based on the scene model, adding one or more candidates to a predictor candidate list; and
selecting a candidate from the predictor candidate list,
wherein coding the current frame of the point cloud data comprises coding the current frame based on the selected candidate.

13. The method of claim 1, further comprising:
determining estimates of positions of points in the current frame of the point cloud data based on a sensor model and the scene model, wherein coding the current frame of the point cloud data based on the scene model comprises:
using the estimates of the positions of points in the current frame of the point cloud data as predictors; and
computing position residuals based on the predictors.

14. The method of claim 13, wherein the sensor model is representative of LIDAR (Light Detection and Ranging) sensors, and wherein the determining the estimates of the positions of the points comprises:
determining first intersections of lasers of the sensor model with the scene model based on at least one of intrinsic or extrinsic sensor parameters of the sensor model,
wherein using the estimates of the positions of the points in the point cloud as the predictors comprises using the first intersections as the predictors.

15. The method of claim 14, further comprising:
obtaining motion information from Global Positioning System data;
compensating for motion between two frames of the point cloud data comprising repositioning a sensor of the sensor model with respect to the scene model based on the motion information;
based on a new position of the sensor associated with the repositioning and based on the sensor model, determining second intersections of lasers with the scene model; and
based on the second intersections of the lasers with the scene model, predicting a point cloud corresponding with a subsequent frame of the two frames of the point cloud data.

16. The method of claim 1, wherein the method further comprises:
transmitting or receiving the scene model in a bitstream.

17. The method of claim 1, wherein the method further comprises:
refraining from transmitting or receiving the scene model in a bitstream.

18. A device for coding point cloud data, the device comprising:
a memory configured to store the point cloud data; and
one or more processors implemented in circuitry and communicatively coupled to the memory, the one or more processors being configured to:
determine or obtain a scene model corresponding with a first frame of the point cloud data, wherein the scene model represents objects within a scene, the objects corresponding with at least a portion of the first frame of the point cloud data; and
code a current frame of the point cloud data based on the scene model.

19. The device of claim 18, wherein the scene model comprises a digital representation of a real-world scene.

20. The device of claim 18, wherein the scene model represents at least one of a road, ground, a vehicle, a pedestrian, a road sign, a traffic light, vegetation, or a building.

21. The device of claim 18, wherein the scene model represents an approximation of the current frame of the point cloud data.

22. The device of claim 18, wherein the scene model comprises a plurality of individual segments.

23. The device of claim 22, wherein the plurality of individual segments comprises a plurality of planes or a plurality of higher order surface approximations.

24. The device of claim 18, wherein the first frame is the current frame, and wherein the one or more processors are further configured to:
determine that the current frame of the point cloud data is an intra frame;
based on the current frame of the point cloud data being the intra frame, signal or parse the scene model; and
use the scene model as a predictor for the current frame of the point cloud data.

25. The device of claim 18, wherein code comprises encode and as part of determining or obtaining the scene model the one or more processors are configured to obtaining a first scene model and determining a second scene model, wherein the one or more processors are further configured to:
determine that the current frame of the point cloud data is not an intra frame;
based on the current frame of the point cloud data not being the intra frame, determine a difference between the first scene model and the second scene model;
use the second scene model as a predictor for the current frame of the point cloud data; and
signal the difference.

26. The device of claim 18, wherein the one or more processors are further configured to:
signal or parse a slice level flag indicative of whether the scene model is utilized for the coding of a particular slice of a plurality of slices of the current frame of the point cloud data.

27. The device of claim 18, wherein as part of determining the scene model the one or more processors are further configured to determine the scene model for a plurality of frames of the point cloud data, and wherein the one or more processors are further configured to:
determine corresponding points belonging to two frames of the plurality of frames of the point cloud data; and
determine a displacement of the corresponding points between the two frames, wherein as part of coding the current frame of the point cloud data based on the scene model, the one or more processors are configured to compensate for motion between the two frames based on the displacement.

28. The device of claim 18, wherein as part of coding the current frame of the point cloud data based on the scene model, the one or more processors are configured to use the scene model as a reference to code point cloud positions.

29. The device of claim 18, wherein code comprises predictive geometry code or transform-based attribute code, and wherein the one or more processors are further configured to:
based on the scene model, add one or more candidates to a predictor candidate list; and
select a candidate from the predictor candidate list,
wherein as part of coding the current frame of the point cloud data, the one or more processors are configured to code the current frame based on the selected candidate.

30. The device of claim 18, wherein the one or more processors are further configured to:
determine estimates of positions of points in the current frame of the point cloud data based on a sensor model and the scene model, wherein as part of coding the current frame of the point cloud data based on the scene model, the one or more processors are configured to:
use the estimates of the positions of points in the current frame of the point cloud data as predictors; and
compute position residuals based on the predictors.

31. The device of claim 30, wherein the sensor model is representative of LIDAR (Light Detection and Ranging) sensors, and wherein as part of determining the estimates of the positions of the points, the one or more processors are further configured to:
determine first intersections of lasers of the sensor model with the scene model based on intrinsic and extrinsic sensor parameters of the sensor model,
wherein as part of using the estimates of the positions of the points in the point cloud as the predictors, the one or more processors are further configured to use the first intersections as the predictors.

32. The device of claim 31, wherein the one or more processors are further configured to:
obtain motion information from Global Positioning System data;
compensate for motion between two frames of the point cloud data comprising repositioning a sensor of the sensor model with respect to the scene model based on the motion information;
based on a new position of the sensor associated with the repositioning, and based on the sensor model, determine second intersections of lasers with the scene model; and
based on the second intersections of the lasers with the scene model, predict a point cloud corresponding with a subsequent frame of the two frames of the point cloud data.

33. The device of claim 18, wherein the device comprises a vehicle, a robot, or a smartphone.

34. The device of claim 18, wherein the one or more processors are further configured to:
transmit or receive the scene model in a bitstream.

35. The device of claim 18, wherein the one or more processors are further configured to:
refrain from transmitting or receiving the scene model in a bitstream.

36. A non-transitory computer-readable storage medium having stored thereon instructions that, when executed, cause one or more processors to:
determine or obtain a scene model corresponding with a first frame of point cloud data, wherein the scene model represents objects within a scene, the objects corresponding with at least a portion of the first frame of the point cloud data; and
code a current frame of the point cloud data based on the scene model.

37. A device for coding point cloud data, the device comprising:
means for determining or obtaining a scene model corresponding with a first frame of the point cloud data, wherein the scene model represents objects within a scene, the objects corresponding with at least a portion of the first frame of the point cloud data; and
means for coding a current frame of the point cloud data based on the scene model.
